(19) United States
(12) Patent Application Publication
(10) Pub. No.: US 2026/0260596 A1
(43) Pub. Date: Sep. 3, 2026

(54) PIXEL CIRCUIT AND DRIVING METHOD THEREOF, ARRAY SUBSTRATE

(71) Applicant: Beijing Visionox Technology Co., Ltd., Beijing (CN)

(72) Inventors: Cuili GAI, Beijing (CN); Enqing GUO, Beijing (CN)

(73) Assignee: Beijing Visionox Technology Co., Ltd., Beijing (CN)

(21) Appl. No.: 19/657,029

(22) Filed: Apr. 24, 2026

(30) Foreign Application Priority Data
Apr. 30, 2025 (CN) 202510572910.5

(51) Int. Cl. G09G 3/20

(52) U.S. Cl. CPC G09G 3/2092; G09G 2310/06

(57) ABSTRACT

The present disclosure discloses a pixel circuit, a driving method thereof, and an array substrate. The pixel circuit includes a driving module; a coupling module, a first terminal of the coupling module being connected to a control terminal of the driving module; a data writing module, a first terminal of the data writing module being connected to a second terminal of the coupling module, and a control terminal of the data writing module being configured to receive a first scan signal; a first initialization module, a first terminal of the first initialization module being connected to the second terminal of the coupling module, and a control terminal of the first initialization module being configured to receive a second scan signal.

### CROSS-REFERENCE TO RELATED APPLICATIONS

This application claims priority to Chinese Patent Application No. 202510572910.5, filed on April 30, 2025, the entire contents of which are incorporated herein by reference.

### FIELD

Embodiments of the present disclosure relate to the field of display technology, and in particular, to a pixel circuit, a driving method thereof, and an array substrate.

### BACKGROUND

A display panel may use oxide thin-film transistors to improve the phenomenon of uneven display brightness. In this case, the display panel requires at least three sets of gate driving circuits to drive pixel circuits composed of oxide thin-film transistors. This results in the gate driving circuits occupying a relatively large border area of the display panel, which is not conducive to achieving a narrow-bezel design for the display panel.

### SUMMARY

The present disclosure provides a pixel circuit, a driving method thereof, and an array substrate to achieve a narrow-bezel design for a display panel.

In a first aspect, an embodiment of the present disclosure provides a pixel circuit, including:

a driving module;

a coupling module, a first terminal of the coupling module being connected to a control terminal of the driving module;

a data writing module, a first terminal of the data writing module being connected to a second terminal of the coupling module, a control terminal of the data writing module being configured to receive a first scan signal;

a first initialization module, a first terminal of the first initialization module being connected to the second terminal of the coupling module, a control terminal of the first initialization module being configured to receive a second scan signal;

In one embodiment, a waveform of an active level of the first scan signal is the same as a waveform of an active level of the second scan signal, and within one frame, a start time of the active level of the first scan signal is later than an end time of the active level of the second scan signal.

In a second aspect, an embodiment of the present disclosure further provides a pixel circuit, including:

a driving module;

a coupling module, a first terminal of the coupling module being connected to a control terminal of the driving module;

a data writing module, a first terminal of the data writing module being connected to a second terminal of the coupling module, a control terminal of the data writing module being configured to receive a first scan signal;

a first threshold compensation module, a first terminal of the first threshold compensation module being connected to the control terminal of the driving module, a second terminal of the first threshold compensation module being connected to a first terminal of the driving module, a control terminal of the first threshold compensation module being configured to receive a second scan signal;

In one embodiment, a waveform of an active level of the first scan signal is the same as a waveform of an active level of the second scan signal, and within one frame, a start time of the active level of the first scan signal is later than an end time of the active level of the second scan signal.

In one embodiment of the present disclosure further provides a driving method for a pixel circuit, for driving the pixel circuit according to the embodiments, the driving method for the pixel circuit including:

in an initialization phase, a first initialization module initializing a second terminal of a coupling module;

in a data writing phase, a data writing module transmitting a data voltage to the second terminal of the coupling module, the coupling module coupling a voltage containing information of the data voltage to a control terminal of a driving module;

in a light-emitting phase, the driving module generating a current according to a voltage at the control terminal of the driving module to drive a light-emitting device to emit light.

In a fourth aspect, an embodiment of the present disclosure further provides an array substrate, including at least one set of cascaded gate driving circuits and the pixel circuit according to the first aspect and the second aspect, and the first scan signal and the second scan signal in the pixel circuit are provided by the same set of gate driving circuits.

In the embodiments of the present disclosure, by arranging the data writing module to be connected to the control terminal of the driving module through the coupling module, when the first scan signal is at an active level, the coupling module can directly couple a voltage containing data voltage information to the control terminal of the driving module, causing a potential at the control terminal of the driving module to be related only to a most recent data voltage provided by the data writing module. By setting the waveform of the active level of the first scan signal to be the same as the waveform of the active level of the second scan signal, not only can normal operation of the pixel circuit be ensured, but also the first scan signal and the second scan signal can be provided by the same set of gate driving circuits. This can reduce the number of gate driving circuits required for the pixel circuit, thereby reducing the border space of the display panel occupied by the gate driving circuits, which is beneficial for achieving a narrow-bezel design for the display panel.

### BRIEF DESCRIPTION OF THE DRAWINGS

FIG. 1 is a schematic structural diagram of a pixel circuit provided by an embodiment of the present disclosure;

FIG. 2 is a schematic structural diagram of another pixel circuit provided by an embodiment of the present disclosure;

FIG. 3 is a schematic structural diagram of another pixel circuit provided by an embodiment of the present disclosure;

FIG. 4 is a schematic structural diagram of another pixel circuit provided by an embodiment of the present disclosure;

FIG. 5 is a schematic structural diagram of another pixel circuit provided by an embodiment of the present disclosure;

FIG. 6 is a schematic timing diagram of a pixel circuit provided by an embodiment of the present disclosure;

FIG. 7 is a schematic structural diagram of another pixel circuit provided by an embodiment of the present disclosure;

FIG. 8 is a schematic timing diagram of a pixel circuit provided by an embodiment of the present disclosure;

FIG. 9 is a schematic structural diagram of another pixel circuit provided by an embodiment of the present disclosure;

FIG. 10 is a schematic structural diagram of another pixel circuit provided by an embodiment of the present disclosure;

FIG. 11 is a timing diagram of another pixel circuit provided by an embodiment of the present disclosure;

FIG. 12 is a schematic structural diagram of another pixel circuit provided by an embodiment of the present disclosure;

FIG. 13 is a schematic structural diagram of another pixel circuit provided by an embodiment of the present disclosure;

FIG. 14 is a schematic structural diagram of another pixel circuit provided by an embodiment of the present disclosure;

FIG. 15 is a schematic structural diagram of another pixel circuit provided by an embodiment of the present disclosure;

FIG. 16 is a timing diagram of another pixel circuit provided by an embodiment of the present disclosure;

FIG. 17 is a schematic structural diagram of another pixel circuit provided by an embodiment of the present disclosure;

FIG. 18 is a schematic structural diagram of another pixel circuit provided by an embodiment of the present disclosure;

FIG. 19 is a schematic structural diagram of another pixel circuit provided by an embodiment of the present disclosure;

FIG. 20 is a schematic structural diagram of another pixel circuit provided by an embodiment of the present disclosure;

FIG. 21 is a schematic flowchart of a driving method for a pixel circuit provided by an embodiment of the present disclosure;

FIG. 22 is a schematic flowchart of a driving method for another pixel circuit provided by an embodiment of the present disclosure;

FIG. 23 is a schematic structural diagram of another pixel circuit provided by an embodiment of the present disclosure;

FIG. 24 is a schematic structural diagram of another pixel circuit provided by an embodiment of the present disclosure;

FIG. 25 is a schematic structural diagram of another pixel circuit provided by an embodiment of the present disclosure;

FIG. 26 is a schematic flowchart of a driving method for a pixel circuit provided by an embodiment of the present disclosure;

FIG. 27 is a schematic structural diagram of an array substrate provided by an embodiment of the present disclosure;

FIG. 28 is a schematic structural diagram of another array substrate provided by an embodiment of the present disclosure;

FIG. 29 is a schematic structural diagram of another array substrate provided by an embodiment of the present disclosure;

FIG. 30 is a schematic structural diagram of another array substrate provided by an embodiment of the present disclosure;

FIG. 31 is a schematic structural diagram of another array substrate provided by an embodiment of the present disclosure;

FIG. 32 is a schematic structural diagram of another array substrate provided by an embodiment of the present disclosure.

### DETAILED DESCRIPTION

The present disclosure will be further described below with reference to the accompanying drawings and embodiments. The specific embodiments described herein are illustrative of the present disclosure and are not intended to limit the present disclosure. It should also be noted that only parts related to the present disclosure, rather than the entire structure, are shown in the drawings.

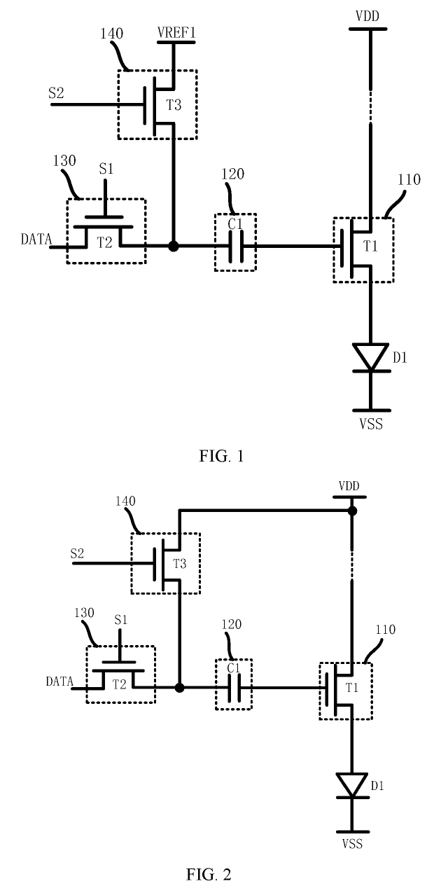

FIG. 1 is a schematic structural diagram of a pixel circuit provided by an embodiment of the present disclosure. As shown in FIG. 1, the pixel circuit includes:

a driving module 110;

a coupling module 120, and a first terminal of the coupling module 120 is connected to a control terminal of the driving module 110;

a data writing module 130, and a first terminal of the data writing module 130 is connected to a second terminal of the coupling module 120, and a control terminal of the data writing module 130 is configured to receive a first scan signal S1;

a first initialization module 140, and a first terminal of the first initialization module 140 is connected to the second terminal of the coupling module 120, and a control terminal of the first initialization module 140 is configured to receive a second scan signal S2;

a waveform of an active level of the first scan signal S1 is the same as a waveform of an active level of the second scan signal S2, and within one frame, a start time of the active level of the first scan signal S1 is later than an end time of the active level of the second scan signal S2.

In one embodiment, when the second scan signal S2 is at an active level, the first initialization module 140 is configured to provide a first initialization voltage to the second terminal of the coupling module 120 to initialize the second terminal of the coupling module 120. The active level duration of the second scan signal S2 can be greater than one row scan time of the display panel, ensuring that the potential control time of the first initialization module 140 over the second terminal of the coupling module 120 meets the requirements of the pixel circuit. After the initialization of the second terminal of the coupling module 120 is completed, the second scan signal S2 transitions from the active level to an inactive level, and the first initialization module 140 stops providing the first initialization voltage to the second terminal of the coupling module 120. At this point, the first scan signal S1 can transition from an inactive level to an active level. When the first scan signal S1 is at an active level, the data writing module 130 can provide a data voltage to the second terminal of the coupling module 120 to achieve the writing of the data voltage. The coupling module 120 has a coupling effect, which can directly couple a voltage containing data voltage information to the control terminal of the driving module 110. The driving module 110 can generate a current based on the voltage at the control terminal to drive the light-emitting device to emit light. Due to the direct coupling effect of the coupling module 120, the potential at the control terminal of the driving module 110 depends only on the last data

voltage from the data writing module 130. This allows flexible timing for the data writing module 130 to provide the data voltage. At this point, by setting the waveform of the active level of the first scan signal S1 to be the same as the waveform of the active level of the second scan signal S2, the first scan signal S1 and the second scan signal S2 can be provided by the same set of gate driving circuits. This can reduce the number of gate driving circuits required by the pixel circuit, thereby reducing the border space occupied by these circuits in the display panel, which is beneficial for achieving a narrow-border design. Here, the same set of gate driving circuits can be multiple stages of cascaded gate driving circuits. For example, the active level duration of the first scan signal S1 can be greater than one row scan time of the display panel, allowing the data writing module 130 to write data voltages corresponding to different rows of pixel circuits multiple times. When the data writing module 130 provides the last input data voltage to the second terminal of the coupling module 120, the coupling module 120 can still directly couple the voltage containing the information of the last input data voltage to the control terminal of the driving module 110. This enables the driving module 110 to generate a current based on the voltage containing the information of the last input data voltage, driving the light-emitting device to emit light, thereby ensuring the light emission reliability of the light-emitting device, i.e., ensuring the display reliability of the display panel. In this embodiment, by configuring the data writing module to be connected to the control terminal of the driving module through the coupling module, when the first scan signal is at an active level, the coupling capacitor can directly couple the voltage containing data voltage information to the control terminal of the driving module. This ensures that the potential at the control terminal of the driving module is only related to the last data voltage provided by the data writing module. By setting the waveform of the active level of the first scan signal to be the same as the waveform of the active level of the second scan signal, not only can the normal operation of the pixel circuit be ensured, but the first scan signal and the second scan signal can also be provided by the same set of gate driving circuits. This reduces the number of gate driving circuits required by the pixel circuit, thereby reducing the border space occupied by the gate driving circuits in the display panel, which is beneficial for achieving a narrow-border design of the display panel. Continuing to refer to FIG. 1, the first terminal of the driving module 110 is connected to the first power line VDD, the second terminal of the driving module 110 is connected to the first

electrode of the light-emitting device D1, the second electrode of the light-emitting device D1 is connected to the second power line VSS, the second terminal of the data writing module 130 is used to input the data voltage DATA, and the second terminal of the first initialization module 140 is used to input the first initialization voltage VREF1. In one embodiment, the first power voltage provided by the first power line VDD is greater than the second power voltage provided by the second power line VSS. When the second scan signal S2 is at an active level, the first initialization module 140 is in a conducting state, and the first initialization module 140 transmits the first initialization voltage VREF1 to the second terminal of the coupling module 120 to initialize the second terminal of the coupling module 120. After the second scan signal S2 transitions from the active level to an inactive level, the first scan signal S1 transitions from an inactive level to an active level. The data writing module 130 transmits the data voltage DATA to the second terminal of the coupling module 120, and the coupling module 120 couples the voltage containing the data voltage DATA information to the control terminal of the driving module 110. This enables the driving module 110 to generate a current based on the voltage at the control terminal, driving the light-emitting device D1 to emit light. For example, the driving module 110 includes a first transistor T1. The gate of the first transistor T1 is connected to the first terminal of the coupling module 120, the first electrode of the first transistor T1 is connected to the first power line VDD, and the second electrode of the first transistor T1 is connected to the first electrode of the light-emitting device D1. In one embodiment, FIG. 1 exemplarily shows that the first transistor T1 is an N-type transistor. The first electrode of the first transistor T1 is indirectly connected to the first power line VDD, and the second electrode of the first transistor T1 is directly connected to the first electrode of the light-emitting device D1. When the voltage at the control terminal of the first transistor T1 is a voltage containing data voltage DATA information, the first transistor T1 can form a current based on the voltage at its second electrode and the voltage at its control terminal. When the first power line VDD is connected to the first electrode of the first transistor T1, the first power line VDD can provide a current path, allowing the current of the first transistor T1 to be transmitted to the light-emitting device D1, driving the light-emitting device D1 to emit light. Continuing to refer to FIG. 1, the data writing module 130 includes a second transistor T2. The first electrode of the second transistor T2 is connected to the second terminal of the coupling

module 120, the gate of the second transistor T2 is used to input the first scan signal S1, and the second electrode of the second transistor T2 is used to input the data voltage DATA.

In one embodiment, FIG. 1 exemplarily shows that the second transistor T2 is an N-type transistor. In this case, the active level of the first scan signal S1 is a high level. During the data writing phase of the pixel circuit, the first scan signal S1 is at a high level, and the second transistor T2 transmits the data voltage DATA to the second terminal of the coupling module 120. The coupling module 120 couples the data voltage DATA to the control terminal of the driving module 110, causing the voltage at the control terminal of the driving module 110 to be a voltage containing information of the data voltage DATA, thereby achieving the writing of the data voltage DATA. In other embodiments, the second transistor T2 may also be a P-type transistor, in which case the active level of the first scan signal S1 is a low level, which is not limited here. Continuing to refer to FIG. 1, the coupling module 120 includes a first capacitor C1. The first terminal of the first capacitor C1 is connected to the control terminal of the driving module 110, and the second terminal of the first capacitor C1 is connected to the first terminal of the data writing module 130. In one embodiment, a capacitor has a coupling function. The coupling module 120 includes the first capacitor C1. After the first initialization module 140 initializes the second terminal of the first capacitor C1, the potential at the second terminal of the first capacitor C1 is the first initialization voltage VREF1. When the data writing module 130 provides the data voltage DATA to the second terminal of the first capacitor C1, the potential at the second terminal of the first capacitor C1 jumps from the first initialization voltage VREF1 to the data voltage DATA. The first terminal of the first capacitor C1 is in a floating state, causing the voltage change at the first terminal of the first capacitor C1 to be the difference between the data voltage DATA and the first initialization voltage VREF1, thereby allowing a voltage containing information of the data voltage DATA to be written to the control terminal of the driving module 110. The driving module 110 generates a current based on the voltage at the control terminal to drive the light-emitting device D1 to emit light. Continuing to refer to FIG. 1, the first initialization module 140 includes a third transistor T3. The gate of the third transistor T3 is used to input the second scan signal S2, the first terminal of the third transistor T3 is connected to the second terminal of the coupling module 120, and the second terminal of the third transistor T3 is used to input the first initialization voltage VREF1. In one embodiment,

FIG. 1 exemplarily shows that the third transistor T3 is an N-type transistor. In this case, the effective level of the second scan signal S2 is a high level. During the initialization phase of the pixel circuit, the second scan signal S2 is at a high level, and the third transistor T3 transmits the first initialization voltage VREF1 to the second terminal of the coupling module 120, thereby initializing the second terminal of the coupling module 120. When the data writing module 130 provides the data voltage DATA to the second terminal of the coupling module 120, it ensures that the voltage change at the second terminal of the coupling module 120 is a fixed value, which is the difference between the data voltage DATA and the first initialization voltage VREF1. Thus, when the coupling module 120 couples the data voltage DATA to the control terminal of the driving module 110, it ensures that the voltage at the control terminal of the driving module 110 is a voltage containing information of the data voltage DATA, ensuring that the current generated by the driving module 110 matches the grayscale corresponding to the data voltage DATA and ensuring the accuracy of light emission by the light-emitting device D1. Additionally, when the pixel circuit is applied to a display panel, the display panel may include multiple rows of pixel circuits. The first initialization modules 140 in different rows of pixel circuits can be turned on row by row to initialize the second terminals of the coupling modules 120 in different rows of pixel circuits. In this case, the second terminal of the first initialization module 140 inputs the first initialization voltage VREF1. When the first initialization module 140 is turned on, the first initialization voltage VREF1 only forms a charging current in one row of pixel circuits. This charging current is relatively small compared to the current generated by the driving module 110, resulting in a relatively small impedance voltage drop for the first initialization voltage VREF1. This improves the voltage consistency at the second terminals of the coupling modules 120 in different pixel circuits, thereby enhancing the current consistency among different pixel circuits and improving the brightness uniformity of the display panel. In other embodiments, the third transistor T3 may also be a P-type transistor, in which case the effective level of the second scan signal S2 is a low level, which is not limited here. Continuing to refer to FIG. 1, the second transistor T2 and the third transistor T3 are transistors of the same type. In this case, the effective levels of the first scan signal S1 and the second scan signal S2 are consistent, allowing the first scan signal S1 and the second scan signal S2 to be provided by the same set of gate driving circuits. This reduces the number of

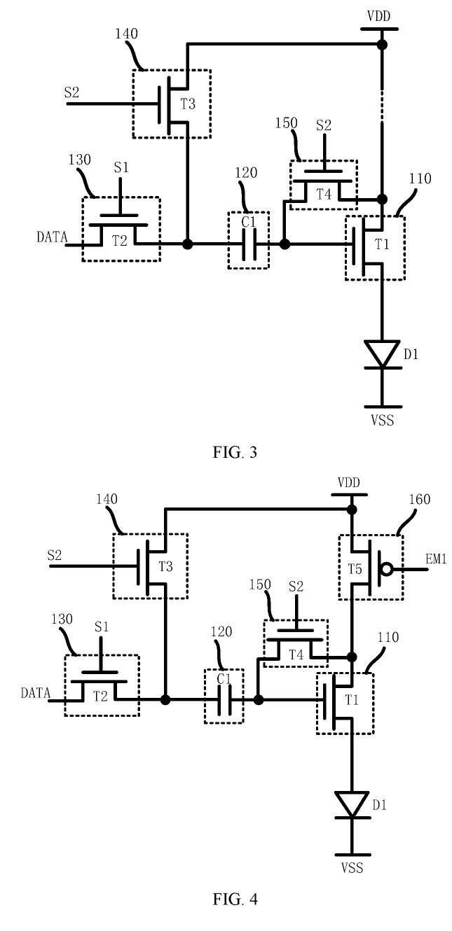

gate driving circuits required for the pixel circuit, thereby minimizing the border space occupied by the gate driving circuits on the display panel, which is conducive to achieving a narrow-border design for the display panel. For example, both the second transistor T2 and the third transistor T3 are N-type transistors, and the effective levels of the first scan signal S1 and the second scan signal S2 are both high levels. FIG. 2 is a schematic structural diagram of another pixel circuit provided by an embodiment of the present disclosure. As shown in FIG. 2, the first power supply voltage provided by the first power line VDD is reused as the first initialization voltage VREF1. This ensures the initialization of the second terminal of the coupling module 120 while avoiding the need for an additional first initialization signal line to provide the first initialization voltage VREF1, which helps simplify the wiring of the display panel. FIG. 3 is a schematic structural diagram of another pixel circuit provided by an embodiment of the present disclosure. As shown in FIG. 3, the pixel circuit further includes: a first threshold compensation module 150. The first terminal of the first threshold compensation module 150 is connected to the first terminal of the driving module 110, the second terminal of the first threshold compensation module 150 is connected to the first terminal of the coupling module 120, and the control terminal of the first threshold compensation module 150 is used to input the second scan signal S2.

In one embodiment, when the second scan signal S2 is at an active level, the first threshold compensation module 150 can connect the first terminal and the control terminal of the driving module 110. When the driving module 110 is turned on, the voltage at the control terminal of the driving module 110 can be discharged through the first threshold compensation module 150 and the driving module 110 until the driving module 110 is turned off, enabling the driving module 110 to achieve threshold voltage compensation via the first threshold compensation module 150, thereby preventing the device characteristics of the driving module 110 from affecting the luminance of the light-emitting device D1 and improving the luminance uniformity of the display panel. Additionally, the control terminal of the first threshold compensation module 150 receives the second scan signal S2, and the waveform of the active level of the second scan signal S2 is the same as that of the active level of the first scan signal S1, ensuring that the time during which the data writing module 130 provides the data voltage DATA coincides with the time during which the first threshold compensation module 150 performs threshold compensation on the voltage at the control

terminal of the driving module 110. This guarantees the reliability of the threshold compensation for the driving module 110, while also allowing the same set of gate driving circuits to provide both the first scan signal S1 and the second scan signal S2 to the pixel circuit, reducing the number of gate driving circuits required for the pixel circuit. Consequently, this reduces the border space occupied by the gate driving circuits on the display panel, facilitating the design of a narrow-bezel display panel. Continuing to refer to FIG. 3, the first threshold compensation module 150 includes a fourth transistor T4. The gate of the fourth transistor T4 is configured to receive the second scan signal S2, the first terminal of the fourth transistor T4 is connected to the first terminal of the driving module 110, and the second terminal of the fourth transistor T4 is connected to the first terminal of the coupling module 120. In one embodiment, FIG. 3 exemplarily illustrates that the fourth transistor T4 is an N-type transistor. When the second scan signal S2 is at a high level, the fourth transistor T4 is turned on, connecting the control terminal and the first terminal of the driving module 110. For example, the driving module 110 may be a first transistor T1. When the gate voltage of the first transistor T1 is at a high level and the first transistor T1 is in a conducting state, the gate voltage of the first transistor T1 can be transmitted through the fourth transistor T4 to the first terminal of the first transistor T1, and then through the first transistor T1 to the second terminal of the first transistor T1, achieving discharge of the gate voltage of the first transistor T1. This continues until the gate voltage of the first transistor T1 equals the sum of the voltage at the second terminal of the first transistor T1 and the threshold voltage, at which point the first transistor T1 turns off. As a result, the gate voltage of the first transistor T1 includes information about the threshold voltage of the first transistor T1, achieving threshold voltage compensation for the first transistor T1. Continuing to refer to FIG. 3, the fourth transistor T4 is of the same type as the second transistor T2 and the third transistor T3. In this case, the effective levels of the first scan signal S1 and the second scan signal S2 are consistent, allowing both the first scan signal S1 and the second scan signal S2 to be provided by the same set of gate driving circuits. This reduces the number of gate driving circuits required for the pixel circuit, thereby decreasing the border space occupied by the gate driving circuits on the display panel and facilitating the design of a narrow-bezel display panel. For example, the fourth transistor T4, the second transistor T2, and the third transistor T3 are all N-type transistors, and the effective levels of

both the first scan signal S1 and the second scan signal S2 are high levels. FIG. 4 is a schematic structural diagram of another pixel circuit provided by an embodiment of the present disclosure. As shown in FIG. 4, the pixel circuit further includes: a first light emission control module 160. The first terminal of the first light emission control module 160 is connected to the first power line VDD, the second terminal of the first light emission control module 160 is connected to the first terminal of the driving module 110, and the control terminal of the first light emission control module 160 is configured to receive a first control signal EM1. The start time of the ineffective level of the first control signal EM1 is later than the start time of the effective level of the second scan signal S2. In one embodiment, as shown in FIG. 4, the first terminal of the driving module 110 is connected to the first power line VDD through the first light emission control module 160. During the light emission phase of the pixel circuit, when the first control signal EM1 is at an effective level, the first terminal of the driving module 110 is connected to the first power line VDD through the first light emission control module 160, providing a current path for the current formed by the driving module 110. This enables the driving module 110 to transmit current to the light-emitting device D1, driving the light-emitting device D1 to emit light. Additionally, the second terminal of the first light emission control module 160 is connected to the first terminal of the driving module 110, meaning the second terminal of the first light emission control module 160 is connected to the first terminal of the first threshold compensation module 150. The start time of the ineffective level of the first control signal EM1 is later than the start time of the effective level of the second scan signal S2. Before the first control signal EM1 transitions from an effective level to an ineffective level, the second scan signal S2 transitions to an effective level. That is, when both the first control signal EM1 and the second scan signal S2 are at effective levels, the first light emission control module 160 and the first threshold compensation module 150 are simultaneously turned on. The first power supply voltage provided by the first power line VDD can be transmitted through the first light emission control module 160 and the first threshold compensation module 150 to the control terminal of the driving module 110, thereby initializing the control terminal of the driving module 110. This ensures that the driving module 110 is in a conducting state, allowing the voltage at the control terminal of the driving module 110 to be

discharged through the driving module 110, achieving threshold compensation for the driving module 110.

When the first light emission control module 160 and the first threshold compensation module 150 are simultaneously turned on, the first power supply voltage charges the control terminal of the driving module 110. When the control terminal voltage of the driving module 110 is greater than the sum of the second terminal voltage and the threshold voltage of the driving module 110, the driving module 110 is turned on, thereby enabling the initialization of the control terminal of the driving module 110. That is, the initialization of the control terminal of the driving module 110 can be achieved when the charging time of the control terminal of the driving module 110 by the first power supply voltage exceeds a set time. Here, the set time is obtained by adding the second terminal voltage and the threshold voltage of the driving module 110 and then dividing by the charging rate of the control terminal of the driving module 110. At this time, the waveform of the first control signal EM1 and/or the waveform of the second scan signal S2 can be adjusted to regulate the duration during which the first control signal EM1 and the second scan signal S2 are simultaneously at an active level, ensuring the initialization of the control terminal of the driving module 110. Additionally, the gate driving circuit includes a light emission control circuit and a scan circuit. The light emission control circuit can provide the first control signal to the pixel circuit based on a light emission start signal and a first clock signal, while the scan circuit can provide the second scan signal to the pixel circuit based on a scan start signal and a second clock signal. When adjusting the waveform of the first control signal EM1 and/or the waveform of the second scan signal S2, at least one of the waveforms of the light emission start signal, the first clock signal, the scan start signal, and the second clock signal can be adjusted to modify the waveform of the first control signal EM1 and/or the waveform of the second scan signal S2. This, in turn, allows for the adjustment of the duration during which the first control signal EM1 and the second scan signal S2 are simultaneously at an active level, ensuring the initialization of the control terminal of the driving module 110.

Continuing to refer to FIG. 4, the first light emission control module 160 includes a fifth transistor T5. The first electrode of the fifth transistor T5 is connected to the first power line VDD, the second electrode of the fifth transistor T5 is connected to the first terminal of the driving module 110, and the gate of the fifth transistor T5 is configured to receive the first control signal EM1.

In one embodiment, FIG. 4 exemplarily shows that the fifth transistor T5 is a P-type transistor. When the first control signal EM1 is at a low level, the fifth transistor T5 is turned on, connecting the first power line VDD to the first terminal of the driving module 110, thereby providing a current path for the current formed by the driving module 110.

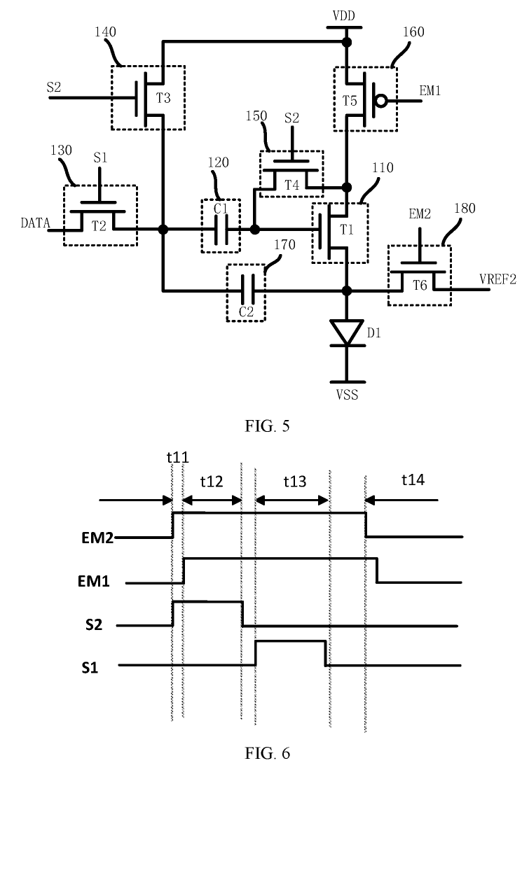

FIG. 5 is a schematic structural diagram of another pixel circuit provided by an embodiment of the present disclosure. As shown in FIG. 5, the pixel circuit further includes:

a storage module 170, where a first terminal of the storage module 170 is connected to either the first terminal or the second terminal of the coupling module 120, and a second terminal of the storage module 170 is connected to the second terminal of the driving module 110;

a second initialization module 180, where a first terminal of the second initialization module 180 is configured to receive a second initialization voltage VREF2, a second terminal of the second initialization module 180 is connected to the second terminal of the storage module 170 and the first electrode of the light-emitting device D1, and a control terminal of the second initialization module 180 is configured to receive a second control signal EM2. The first control signal EM1 is multiplexed as the second control signal EM2; or, the active level waveform of the first control signal EM1 is the same as the active level waveform of the second control signal EM2, and within one frame, the start time of the inactive level of the first control signal EM1 is later than the start time of the active level of the second control signal EM2.

In one embodiment, FIG. 5 exemplarily shows that the first terminal of the storage module 170 is connected to the second terminal of the coupling module 120. At the same time, the active level waveform of the first control signal EM1 is the same as the active level waveform of the second control signal EM2, and within one frame, the start time of the inactive level of the first control signal EM1 is later than the start time of the active level of the second control signal EM2. This allows the same set of gate driving circuits at different stages to simultaneously provide the first control signal EM1 and the second control signal EM2 to the pixel circuit, which can reduce the number of gate driving circuits required by the pixel circuit and further facilitate the design of a narrow bezel for the display panel. During the initialization phase of the pixel circuit, the second control signal EM2 is at an active level, the first control signal EM1 is at an active level, and the second scan signal S2 is at an active level. The second initialization module 180 provides the second initialization voltage VREF2 to the second terminal of the driving module 110, the first electrode of the light-emitting device D1, and the second terminal of the storage module 170, initializing the second terminal of the driving module 110, the first electrode of the light-emitting device D1, and the second terminal of the storage module 170, and maintaining the potential at the second terminal of the storage module 170 at the fixed second initialization voltage VREF2. Simultaneously, the first initialization module 140 initializes the second terminal of the coupling module 120, and the first power supply voltage provided by the first power line VDD initializes the first terminal of the coupling module 120 through the first light emission control module 160 and the first threshold compensation module 150, causing the voltage at the first terminal of the coupling module 120 to be the first power supply voltage Vdd. The voltages at the second terminal of the coupling module 120 and the first terminal of the storage module 170 are multiplexed as the first power supply voltage Vdd, while the voltage at the second terminal of the storage module 170 is the second initialization voltage VREF2, which is also the voltage at the second terminal of the driving module 110. Then, during the threshold compensation phase of the pixel circuit, the first light emission control module 160 is turned off, and the first threshold compensation module 150 performs threshold compensation on the control terminal voltage of the driving module 110. When the control terminal voltage of the driving module 110 reaches the sum of the second initialization voltage VREF2 and the threshold voltage, the driving module 110 is turned off, achieving threshold compensation for the driving module 110.

In addition, the start time of the inactive level of the first control signal EM1 is later than the start time of the active level of the second control signal EM2, and the second initialization module 180 can maintain the voltage at the second terminal of the driving module 110 as the second initialization voltage VREF2. This ensures that when the driving module 110 generates a current based on the control terminal voltage and the second terminal voltage, the impedance voltage drop of the second power supply voltage provided by the second power line VSS and the voltage variation across the aging light-emitting device D1 do not affect the current generated by the driving module 110, thereby improving the brightness uniformity of the display panel.

Continuing to refer to FIG. 5, the storage module 170 includes a second capacitor C2. The first terminal of the second capacitor C2 is connected to the second terminal of the coupling module 120, and the second terminal of the second capacitor C2 is connected to the second terminal of the second initialization module 180 and the first electrode of the light-emitting device D1.

In one embodiment, FIG. 5 exemplarily shows that the first terminal of the second capacitor C2 is connected to the second terminal of the coupling module 120. After the initialization phase of the pixel circuit, the potential at the first terminal of the second capacitor C2 is the first power supply voltage Vdd, and the potential at the second terminal of the second capacitor C2 is the second initialization voltage VREF2. During the threshold compensation phase of the pixel circuit, the second initialization module 180 maintains the potential at the second terminal of the driving module 110 as the second initialization voltage VREF2. The first threshold compensation module 150 discharges the control terminal voltage of the driving module 110 to the sum of the second initialization voltage VREF2 and the threshold voltage VTH, turning off the driving module 110. During the data writing phase of the pixel circuit, the data writing module 130 writes the data voltage DATA to the second terminal of the coupling module 120, causing the potential at the second terminal of the coupling module 120 and the first terminal of the second capacitor C2 to jump from the first power supply voltage Vdd to the data voltage DATA. Consequently, the voltage at the first terminal of the coupling module 120 becomes the sum of the second initialization voltage VREF2 and the threshold voltage VTH, plus the difference between the data voltage DATA and the first power supply voltage Vdd, i.e., VREF2+VTH+(DATA-Vdd). This ensures that the control terminal voltage of the driving module 110 includes information about the data voltage DATA while preserving information about the threshold voltage VTH of the driving module 110. During the light-emitting phase of the pixel circuit, the current generated by the driving module 110 is positively correlated with the voltage difference between the control terminal voltage and the second terminal voltage of the driving module 110 minus the threshold voltage. In one embodiment, the current I of the driving module 110 is I=1/2×u×Cox×W/L×(DATA-Vdd)², where u is the carrier mobility of the first transistor T1 in the driving module 110, Cox is the unit capacitance of the gate oxide layer of the first transistor T1, and W/L is the width-to-length ratio of the first transistor T1. Thus, it can be seen that the current of the driving module 110 is independent of the threshold voltage of the driving module 110, the impedance voltage drop of the second power supply voltage provided by the second power line VSS, and the voltage variation across the aging light-emitting device D1, thereby improving the brightness uniformity of the display panel.

When the voltage at the second terminal of the third transistor T3 is the first initialization voltage VREF1, the current I of the driving module 110 is I=1/2×u×Cox×W/L×(DATA-VREF1)². This can further compensate for the threshold voltage of the driving module 110, the impedance voltage drop of the first power supply voltage provided by the first power line VDD, the impedance voltage drop of the second power supply voltage provided by the second power line VSS, and the voltage variation across the aging light-emitting device D1, thereby improving the brightness uniformity of the display panel.

Continuing to refer to FIG. 5, the second initialization module 180 includes a sixth transistor T6. The first terminal of the sixth transistor T6 is configured to receive the second initialization voltage VREF2, the second terminal of the sixth transistor T6 is connected to the first electrode of the light-emitting device D1 and the second terminal of the storage module 170, and the gate of the sixth transistor T6 is configured to receive the second control signal EM2.

In one embodiment, FIG. 5 exemplarily shows that the sixth transistor T6 is an N-type transistor. When the second control signal EM2 is at a high level, the sixth transistor T6 is turned on, allowing the second initialization voltage VREF2 to be transmitted through the sixth transistor T6 to the first electrode of the light-emitting device D1 and the second terminal of the storage module 170 for initialization. For example, the difference between the second initialization voltage VREF2 and the second power supply voltage provided by the second power line VSS is less than the turn-on voltage of the light-emitting device D1, preventing the light-emitting device D1 from emitting light unintentionally under the influence of the second initialization voltage VREF2.

Continuing to refer to FIG. 5, the fifth transistor T5 is a P-type transistor, the sixth transistor T6 is an N-type transistor, and the start time of the high level of the first control signal EM1 is later than the start time of the high level of the second control signal EM2.

In one embodiment, when the fifth transistor T5 is a P-type transistor and the sixth transistor T6 is an N-type transistor, the active level of the first control signal EM1 is a low level, and the inactive level is a high level. The active level of the second control signal EM2 is a high level, and the inactive level is a low level. In this case, the start time of the high level of the first control signal EM1 can be set later than the start time of the high level of the second control signal EM2, ensuring that the start time of the invalid level of the first control signal EM1 is later than the start time of the valid level of the second control signal EM2.

For example, FIG. 6 is a schematic timing diagram of a pixel circuit according to an embodiment of the present disclosure. Here, EM1 is the timing diagram of the first control signal, EM2 is the timing diagram of the second control signal, S1 is the timing diagram of the first scan signal, and S2 is the timing diagram of the second scan signal. The operation process of the pixel circuit is described below with reference to FIG. 5 and FIG. 6.

During the initialization phase t11, the first control signal EM1 is at a low level, the second control signal EM2 is at a high level, the first scan signal S1 is at a low level, and the second scan signal S2 is at a high level. The second transistor T2 is turned off, while the third transistor T3, the fourth transistor T4, the fifth transistor T5, and the sixth transistor T6 are turned on. The voltage at the second terminal of the first capacitor C1 is the first power supply voltage Vdd, and the voltage at the second terminal of the second capacitor C2 is the second initialization voltage VREF2. The voltage at the first terminal of the first capacitor C1 is the first power supply voltage Vdd, causing the first transistor T1 to turn on. Simultaneously, the first power supply voltage provided by the first power line VDD can be discharged through the fifth transistor T5, the first transistor T1, and the sixth transistor T6, preventing the light-emitting device D1 from emitting light unintentionally, thereby improving the contrast ratio of the display panel.

During the threshold compensation phase t12, the first control signal EM1 is at a high level, the second control signal EM2 is at a high level, the first scan signal S1 is at a low level, and the second scan signal S2 is at a high level. The fifth transistor T5 and the second transistor T2 are turned off, while the third transistor T3, the fourth transistor T4, and the sixth transistor T6 are turned on. The voltage at the second terminal of the first capacitor C1 remains at the first power supply voltage Vdd, and the voltage at the second terminal of the second capacitor C2 remains at the second initialization voltage VREF2. The gate of the first transistor T1 discharges through the fourth transistor T4, the first transistor T1, and the sixth transistor T6 until the gate voltage of the first transistor T1 becomes the sum of the second initialization voltage VREF2 and the threshold voltage VTH, i.e., VREF2+VTH.

During the data writing phase t13, the first control signal EM1 is at a high level, the second control signal EM2 is at a high level, the first scan signal S1 is at a high level, and the second scan signal S2 is at a low level. The third transistor T3, the fourth transistor T4, and the fifth transistor T5 are turned off, while the second transistor T2 and the sixth transistor T6 are turned on. The voltage at the second terminal of the first capacitor C1 jumps from the first power supply voltage Vdd to the data voltage DATA. Due to the coupling effect of the first capacitor C1, the change in voltage at the first terminal of the first capacitor C1 is equal to the data voltage DATA minus the first power supply voltage Vdd. Thus, the voltage at the first terminal of the first capacitor C1 becomes VREF2+VTH+(DATA-Vdd), which is the gate voltage of the first transistor T1. The voltage at the second terminal of the second capacitor C2 remains at the second initialization voltage VREF2, meaning the second terminal voltage of the first transistor T1 is the second initialization voltage VREF2.

During the light-emitting phase t14, the first control signal EM1 is at a low level, the second control signal EM2 is at a low level, the first scan signal S1 is at a low level, and the second scan signal S2 is at a low level. The second transistor T2, the third transistor T3, the fourth transistor T4, and the sixth transistor T6 are turned off, while the fifth transistor T5 is turned on. The first transistor T1 generates a current based on the gate-source voltage difference, i.e., the current I of the first transistor T1 is I=1/2×u×Cox×W/L×(DATA-Vdd)². Simultaneously, the fifth transistor T5 provides a current path, allowing the current provided by the first transistor T1 to be transmitted to the light-emitting device D1, thereby driving the light-emitting device D1 to emit light.

In some embodiments, FIG. 7 is a schematic structural diagram of another pixel circuit provided by an embodiment of the present disclosure. As shown in FIG. 7, the fifth transistor T5 is an N-type transistor, the sixth transistor T6 is a P-type transistor, and the start time of the low level of the first control signal EM1 is later than the start time of the low level of the second control signal EM2.

In one embodiment, when the fifth transistor T5 is an N-type transistor and the sixth transistor T6 is a P-type transistor, the active level of the first control signal EM1 is a high level, and the inactive level is a low level. The active level of the second control signal EM2 is a low level, and the inactive level is a high level. In this case, the start time of the low level of the first control signal EM1 can be set later than the start time of the low level of the second control signal EM2, meaning the start time of the inactive level of the first control signal EM1 is later than the start time of the active level of the second control signal EM2.

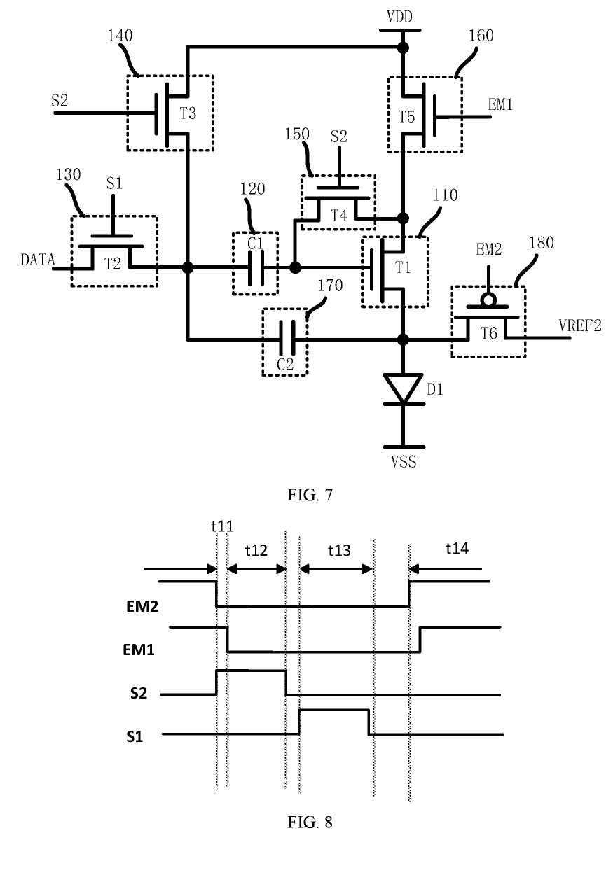

For example, FIG. 8 is a schematic timing diagram of a pixel circuit provided by an embodiment of the present disclosure. Here, EM1 is the timing diagram of the first control signal, EM2 is the timing diagram of the second control signal, S1 is the timing diagram of the first scan signal, and S2 is the timing diagram of the second scan signal. As shown in FIG. 8, compared to FIG. 6, the high and low levels of the first control signal EM1 are opposite, and the high and low levels of the second control signal EM2 are opposite. The specific working process is similar to that of FIG. 6 and will not be repeated here.

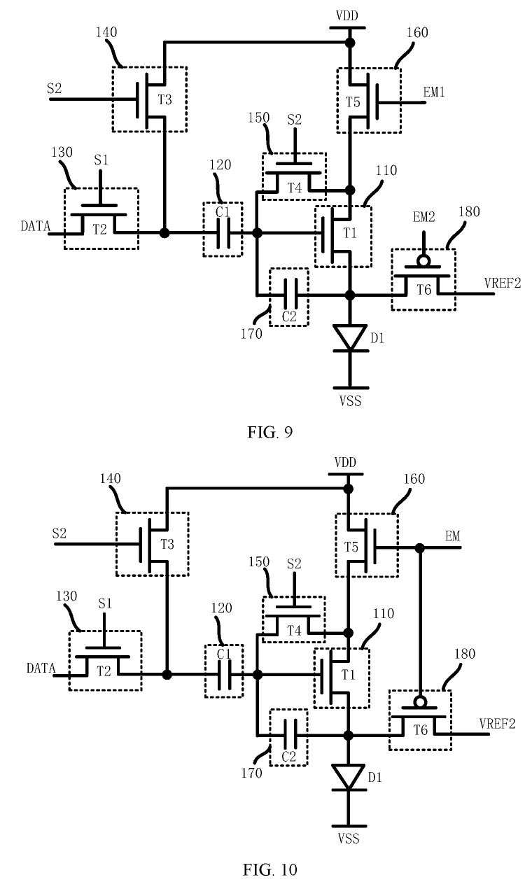

In some embodiments, FIG. 9 is a schematic structural diagram of another pixel circuit provided by an embodiment of the present disclosure. As shown in FIG. 9, the first terminal of the storage module 170 is connected to the first terminal of the coupling module 120. In this configuration, between the control terminal and the second terminal of the driving module 110, the storage module 170 and the coupling module 120 are effectively connected in parallel. Compared to the embodiments where the first terminal of the storage module 170 is connected to the second terminal of the coupling module 120, which results in the storage module 170 and the coupling module 120 being effectively connected in series between the control terminal and the second terminal of the driving module 110, this configuration can increase the storage capacity of the storage module 170 for storing the control terminal voltage of the driving module 110. This is beneficial for reducing the layout space occupied by the storage module 170 in the display panel, thereby facilitating an increase in the pixel density of the display panel.

When the storage module 170 includes a second capacitor C2 and the coupling module 120 includes a first capacitor C1, during the initialization phase of the pixel circuit, the voltage at the first terminal of the second capacitor C2 is charged through the first light emission control module 160 and the first threshold compensation module 150.

During the threshold compensation phase of the pixel circuit, the first threshold compensation module 150 discharges the voltage at the first terminal of the second capacitor C2 to the sum of the second initialization voltage VREF2 and the threshold voltage VTH.

During the data writing phase of the pixel circuit, when the voltage at the second terminal of the first capacitor C1 is the data voltage DATA, due to the coupling effect of the first capacitor C1, the voltage at the first terminal of the first capacitor C1 becomes VREF2+VTH+c1/(c1+c2)×(DATA-Vdd); where c1 is the capacitance value of the first capacitor C1, and c2 is the capacitance value of the second capacitor C2.

During the light emission phase of the pixel circuit, the current I of the driving module 110 is I=1/2×u×Cox×W/L×[c1/(c1+c2)×(DATA-Vdd)]².

In some embodiments, FIG. 10 is a schematic structural diagram of another pixel circuit provided by an embodiment of the present disclosure.

As shown in FIG. 10, the first control signal EM1 is multiplexed as the second control signal EM2.

This can reduce the wiring requirements of the display panel and is beneficial for improving the pixel density of the display panel.

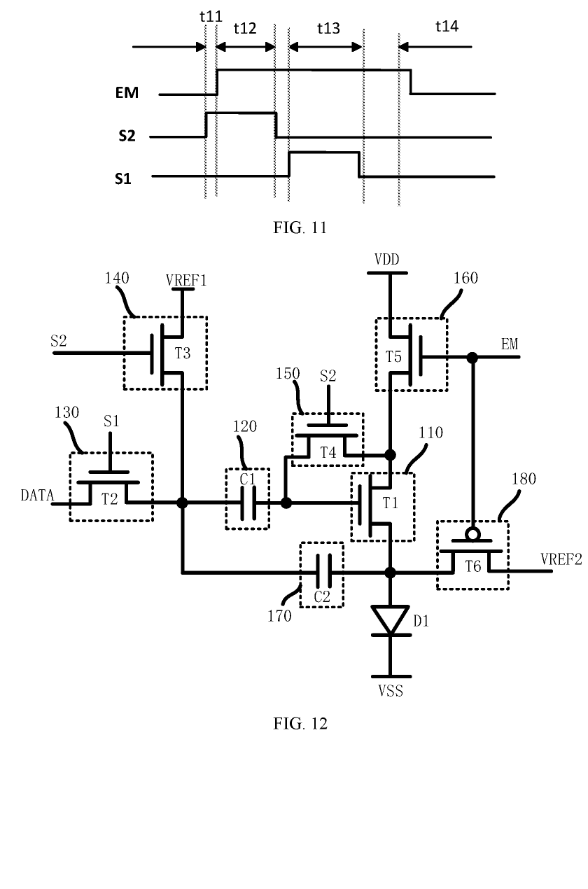

For example, FIG. 11 is a timing diagram of another pixel circuit provided by an embodiment of the present disclosure.

Here, EM is the timing diagram of the control signal, used to provide the first control signal EM1 and the second control signal EM2 to the pixel circuit; S1 is the timing diagram of the first scan signal; S2 is the timing diagram of the second scan signal.

The operation process of the pixel circuit is described below in conjunction with FIG. 10 and FIG. 11.

During the initialization phase t21, the control signal is at a low level, the first scan signal S1 is at a low level, and the second scan signal S2 is at a high level.

The second transistor T2 and the sixth transistor T6 are turned off; the third transistor T3, the fourth transistor T4, and the fifth transistor T5 are turned on.

The voltage at the second terminal of the first capacitor C1 is the first power supply voltage Vdd, and the voltage at the first terminal of the first capacitor C1 is the first power supply voltage Vdd, causing the first transistor T1 to turn on.

During the threshold compensation phase t22, the control signal is at a high level, the first scan signal S1 is at a low level, and the second scan signal S2 is at a high level.

The fifth transistor T5 and the second transistor T2 are turned off; the third transistor T3, the fourth transistor T4, and the sixth transistor T6 are turned on.

The voltage at the second terminal of the first capacitor C1 remains at the first power supply voltage Vdd, and the voltage at the second terminal of the second capacitor C2 is the second initialization voltage VREF2.

The gate of the first transistor T1 discharges through the fourth transistor T4, the first transistor T1, and the sixth transistor T6 until the gate voltage of the first transistor T1 becomes the sum of the second initialization voltage VREF2 and the threshold voltage VTH, i.e., VREF2+VTH.

During the data writing phase t23, the control signal is at a high level, the first scan signal S1 is at a high level, and the second scan signal S2 is at a low level.

The third transistor T3, the fourth transistor T4, and the fifth transistor T5 are turned off; the second transistor T2 and the sixth transistor T6 are turned on.

The voltage at the second terminal of the first capacitor C1 jumps from the first power supply voltage Vdd to the data voltage DATA.

Due to the coupling effect of the first capacitor C1, the change in voltage at the first terminal of the first capacitor C1 is equal to the data voltage DATA minus the first power supply voltage Vdd, i.e., the voltage at the first terminal of the first capacitor C1 becomes VREF2+VTH+(DATA-Vdd), which is the gate voltage of the first transistor T1.

The voltage at the second terminal of the second capacitor C2 remains at the second initialization voltage VREF2, i.e., the voltage at the second terminal of the first transistor T1 is the second initialization voltage VREF2.

During the light emission phase t24, the control signal is at a low level, the first scan signal S1 is at a low level, and the second scan signal S2 is at a low level.

The second transistor T2, the third transistor T3, the fourth transistor T4, and the sixth transistor T6 are turned off; the fifth transistor T5 is turned on.

The first transistor T1 generates a current based on the gate-source voltage difference, i.e., the current I of the first transistor T1 is I=1/2×u×Cox×W/L×(DATA-Vdd)².

Simultaneously, the fifth transistor T5 provides a current path, allowing the current provided by the first transistor T1 to be transmitted to the light-emitting device D1, thereby driving the light-emitting device D1 to emit light.

FIG. 5, FIG. 7, FIG. 9, and FIG. 10 exemplarily show partial schematic structural diagrams of the pixel circuit.

In other embodiments, other pixel circuit structures may also be configured, which are not limited herein.

For example, FIG. 12 is a schematic structural diagram of another pixel circuit provided by an embodiment of the present disclosure.

As shown in FIG. 12, it is also possible to configure the second terminal of the third transistor T3 to input the first initialization voltage VREF1, connect the first terminal of the second capacitor C2 to the second terminal of the coupling module 120, and multiplex the first control signal EM1 as the second control signal EM2.

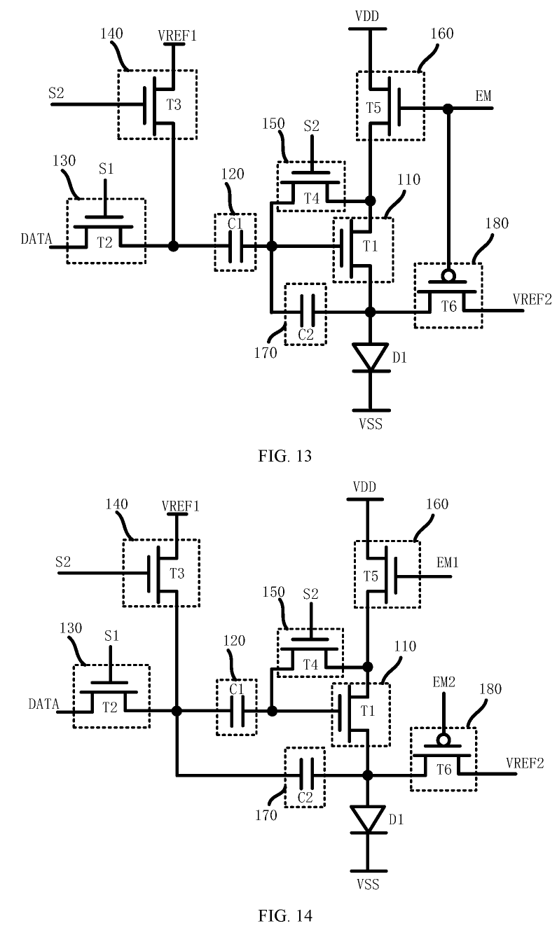

FIG. 13 is a schematic structural diagram of another pixel circuit provided by an embodiment of the present disclosure.

As shown in FIG. 13, it is also possible to configure the second terminal of the third transistor T3 to input the first initialization voltage VREF1, connect the first terminal of the second capacitor C2 to the first terminal of the coupling module 120, and multiplex the first control signal EM1 as the second control signal EM2.

FIG. 14 is a schematic structural diagram of another pixel circuit provided by an embodiment of the present disclosure.

As shown in FIG. 14, it is also possible to configure the second terminal of the third transistor T3 to input the first initialization voltage VREF1, connect the first terminal of the second capacitor C2 to the second terminal of the coupling module 120, and set the start time of the high level of the first control signal EM1 to be later than the start time of the high level of the second control signal EM2.

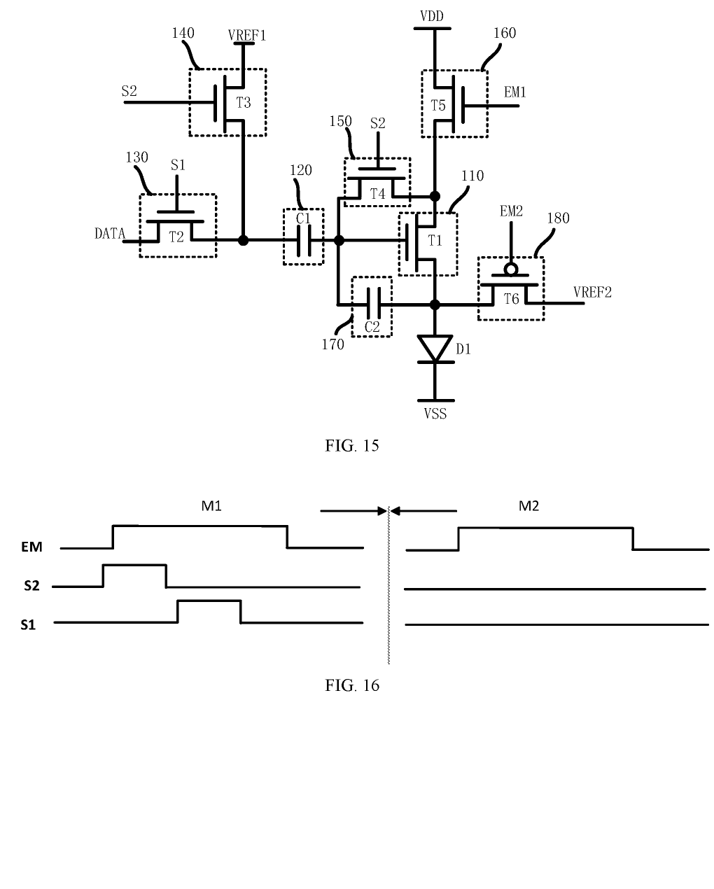

FIG. 15 is a schematic structural diagram of another pixel circuit provided by an embodiment of the present disclosure.

As shown in FIG. 15, it is also possible to configure the second terminal of the third transistor T3 to input the first initialization voltage VREF1, connect the first terminal of the second capacitor C2 to the first terminal of the coupling module 120, and set the start time of the high level of the first control signal EM1 to be later than the start time of the high level of the second control signal EM2.

In some embodiments, a display frame of the pixel circuit includes at least two sub-frames; one of the sub-frames is a write frame, and the remaining sub-frames are hold frames; frequencies of the first scan signal and the second scan signal are the same as a frequency of the display frame, and effective levels of the first scan signal and the second scan signal are located in the write frame; frequencies of the first control signal and the second control signal are the same as a frequency of the sub-frame.

In one embodiment, the display panel may include multiple operating modes, and different operating modes correspond to different display frames. For example, when the display panel operates in a normal mode, the display frame of the display panel may be a base frame. For instance, the frequency of the base frame of the display panel may be 60 Hz or 120 Hz. When the display panel operates in a low-frequency mode, the display frame of the display panel may include multiple sub-frames, each sub-frame corresponding to one base frame. When the pixel circuit operates in the low-frequency mode, the display frame of the pixel circuit may include at least two consecutive sub-frames. The at least two consecutive sub-frames may include one write frame, with the remainder being hold frames. In the write frame, the first scan signal, the second scan signal, the first control signal, and the second control signal enable normal display of the light-emitting device driven by the pixel circuit according to operational requirements of the pixel circuit. For example, in the write frame, the pixel circuit achieves normal display of the light-emitting device driven by the pixel circuit through an initialization stage, a threshold compensation stage, a data writing stage, and an emission stage. In the hold frame, the pixel circuit maintains the control terminal voltage of the driving module at the time of the write frame to sustain the display state of the light-emitting device driven by the pixel circuit. At this time, by setting the frequencies of the first scan signal and the second scan signal to be the same as the frequency of the display frame, and placing the effective levels of the first scan signal and the second scan signal in the write frame, while setting the frequencies of the first control signal and the second control signal to be the same as the frequency of the sub-frame, it can be ensured that the pixel circuit drives the light-emitting device for normal display through the initialization stage, threshold compensation stage, data writing stage, and emission stage in the write frame. Simultaneously, in the hold frame, the first scan signal and the second scan signal remain at invalid levels, and the first control signal and the second control signal have the same waveforms as in the write frame, enabling the second initialization module to perform high-frequency reset on the first electrode of the light-emitting device, thereby improving low-frequency flicker phenomena of the display panel.

For example, FIG. 16 is a timing diagram of another pixel circuit provided by an embodiment of the present disclosure. Here, EM is a timing diagram of a control signal, used to provide the first control signal EM1 and the second control signal EM2 to the pixel circuit; S1 is a timing diagram of the first scan signal; S2 is a timing diagram of the second scan signal. As shown in FIG. 15, in the write frame M1, the timings of the control signal EM, the first scan signal S1, and the second scan signal S2 are the same as those of the pixel circuit provided in FIG. 11. At this time, the pixel circuit can drive the light-emitting device to emit light according to the data voltage through the initialization stage, threshold compensation stage, data writing stage, and emission stage. In the hold frame M2, the first scan signal S1 and the second scan signal S2 are at low levels, i.e., invalid levels, and the pixel circuit does not perform the initialization stage, threshold compensation stage, or data writing stage. The gate voltage of the first transistor T1 is maintained at the gate voltage during the emission stage of the write frame M1, allowing the hold frame M2 to sustain the emission state of the light-emitting device. Meanwhile, in the hold frame M2, the waveform of the control signal EM is the same as that in the write frame M1, enabling the second initialization module to still initialize the light-emitting device before the emission stage of the hold frame M2, thereby performing high-frequency reset on the first electrode of the light-emitting device and improving low-frequency flicker phenomena of the display panel.

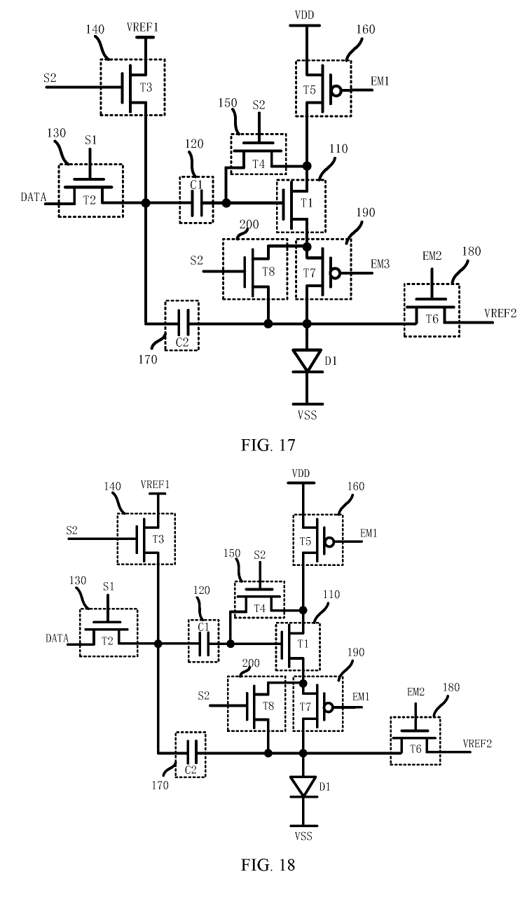

FIG. 17 is a schematic structural diagram of another pixel circuit provided by an embodiment of the present disclosure. As shown in FIG. 17, the pixel circuit further includes:

a second emission control module 190, a control terminal of the second emission control module 190 is configured to receive a third control signal EM3, a first terminal of the second emission control module 190 is connected to a second terminal of the driving module 110, and a second terminal of the second emission control module 190 is connected to a first electrode of the light-emitting device D1; a start time of an invalid level of the third control signal EM3 precedes a start time of an invalid level of the first control signal EM1, or the start time of the invalid level of the third control signal EM3 is the same as the start time of the invalid level of the first control signal EM1;

a second threshold compensation module 200, a control terminal of the second threshold compensation module 200 is configured to receive the second scan signal S2, a first terminal of the second threshold compensation module 200 is connected to the second terminal of the driving module 110, and a second terminal of the second threshold compensation module 200 is connected to the first electrode of the light-emitting device D1.

In one embodiment, when the third control signal EM3 is at an invalid level, the second emission control module 190 can cut off the current path between the second terminal of the driving module 110 and the first electrode of the light-emitting device D1. The start time of the invalid level of the third control signal EM3 precedes the start time of the invalid level of the first control signal EM1, or the start time of the invalid level of the third control signal EM3 is the same as the start time of the invalid level of the first control signal EM1. Before the first control signal EM1 controls the first emission control module 160 to turn off, the third control signal EM3 controls the second emission control module 190 to turn off. This ensures that when the first emission control module 160 is turned off and the potential at the first terminal of the driving module 110 is in a floating state, the discharge path for the voltage at the first terminal of the driving module 110 can be cut off before the first terminal voltage of the driving module 110 discharges. Thereby, the stability of the voltage at the first terminal of the driving module 110 can be maintained, and further, floating of the control terminal voltage of the driving module 110 due to coupling through parasitic capacitance can be avoided, improving the stability of the control terminal voltage of the driving module 110 and consequently mitigating flicker phenomena of the display panel. For example, when the display panel operates at low frequency, the second emission control module 190 can be controlled to turn off before or at the same time as the first emission control module 160 turns off during the hold frame, preventing the control terminal voltage of the driving module 110 from floating in the hold frame and improving low-frequency flicker phenomena of the display panel.

In addition, the second threshold compensation module 200 is connected in parallel with the second emission control module 190. The control terminal of the second threshold compensation module 200 is configured to receive the second scan signal S2. When the second scan signal S2 is at an active level, the first threshold compensation module 150 and the second threshold compensation module 200 are simultaneously turned on, and the control terminal voltage of the drive module 110 can be transmitted to the second initialization module 180 through the first threshold compensation module 150, the drive module 110, and the second threshold compensation module 200, causing the control terminal voltage of the drive module 110 to discharge, thereby achieving threshold compensation for the drive module 110. At this time, the second threshold compensation module 200 can provide a discharge path for the control terminal voltage of the drive module 110 when the second light emission control module 190 is turned off, ensuring the reliability of threshold compensation for the driving module 110.

Continuing to refer to FIG. 17, the second emission control module 190 includes a seventh transistor T7. The gate of the seventh transistor T7 is configured to receive the third control signal EM3, the first terminal of the seventh transistor T7 is connected to the second terminal of the driving module 110, and the second terminal of the seventh transistor T7 is connected to the first electrode of the light-emitting device D1.

In one embodiment, FIG. 17 exemplarily shows that the seventh transistor T7 is a P-type transistor. When the third control signal EM3 is at a low level, the seventh transistor T7 is turned on, and the current formed by the first transistor T1 can be transmitted to the light-emitting device D1 through the seventh transistor T7, driving the light-emitting device D1 to emit light. When the third control signal EM3 is at a high level, the first control signal EM1 is at a high level, and the fifth transistor T5 is turned off, causing the potential at the first terminal of the first transistor T1 to be in a floating state. At this time, the seventh transistor T7 is turned off, preventing the voltage at the first terminal of the first transistor T1 from discharging through the first transistor T1, thereby avoiding floating of the gate voltage of the first transistor T1 due to coupling through parasitic capacitance, improving the stability of the gate voltage of the first transistor T1, and consequently mitigating flicker phenomena in the display panel.

Continuing to refer to FIG. 17, the fifth transistor T5 and the seventh transistor T7 are of the same transistor type. The first control signal EM1 and the third control signal EM3 can be provided to the pixel circuit by the same set of gate drive circuits, which helps reduce the number of gate drive circuits required for the pixel circuit and is conducive to achieving a narrow bezel design for the display panel.

Continuing to refer to FIG. 17, the second threshold compensation module 200 includes an eighth transistor T8. The gate of the eighth transistor T8 is configured to receive the second scan signal S2, the first terminal of the eighth transistor T8 is connected to the second terminal of the driving module 110, and the second terminal of the eighth transistor T8 is connected to the first electrode of the light-emitting device D1.

In one embodiment, FIG. 17 exemplarily shows that the eighth transistor T8 is an N-type transistor. When the second scan signal S2 is at a high level, the eighth transistor T8 is turned on, and simultaneously the fourth transistor T4 is turned on. After the gate voltage of the first transistor T1 is initialized, causing the first transistor T1 to turn on, the gate voltage of the first transistor T1 can discharge through the fourth transistor T4, the first transistor T1, and the eighth transistor T8, ensuring the discharge reliability of the gate voltage of the first transistor T1 and thereby guaranteeing the reliability of the threshold voltage compensation for the first transistor T1.

The eighth transistor T8 can be of the same type as the fourth transistor T4. When the second scan signal S2 is at an active level, the eighth transistor T8 and the fourth transistor T4 can be turned on simultaneously, ensuring the discharge reliability of the gate voltage of the first transistor T1 and thereby guaranteeing the reliability of the threshold voltage compensation for the first transistor T1.

FIG. 18 is a schematic structural diagram of another pixel circuit provided by an embodiment of the present disclosure. As shown in FIG. 18, the first control signal EM1 is reused as the third control signal EM3, such that the start time of the inactive level of the third control signal EM3 is the same as the start time of the inactive level of the first control signal EM1. When the first control signal EM1 controls the first light emission control module 160 to turn off, it simultaneously controls the second emission control module 190 to turn off. This not only cuts off the current path between the second terminal of the driving module 110 and the light-emitting device D1 through the second emission control module 190 but also reduces the wiring of the display panel, which is beneficial for increasing the pixel density of the display panel. Moreover, the first control signal EM1 and the third control signal EM3 are provided by the same set of gate drive circuits, which can reduce the number of gate drive circuits required for the pixel circuit and thereby achieve a narrow bezel design for the display panel.

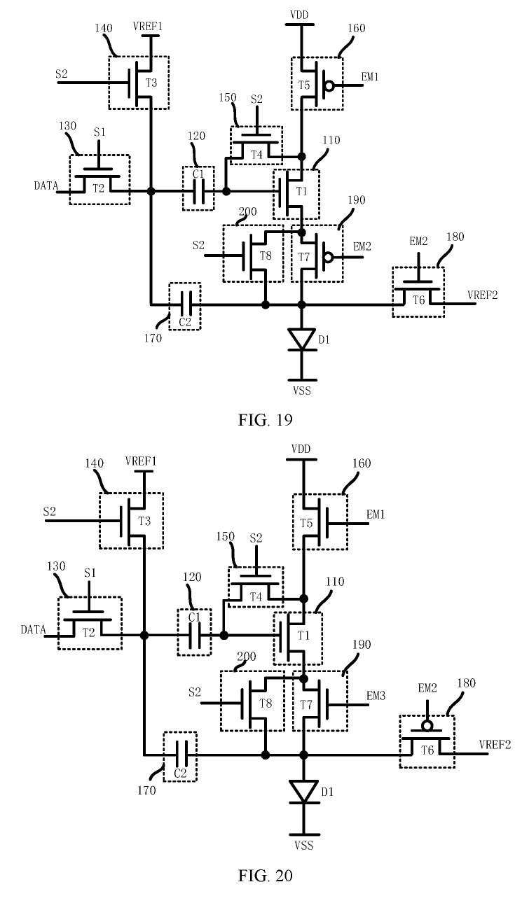

FIG. 19 is a schematic structural diagram of another pixel circuit provided by an embodiment of the present disclosure. As shown in FIG. 19, the second control signal EM2 is reused as the third control signal EM3.

In one embodiment, the first control signal EM1 is multiplexed as the second control signal EM2; or, the active level waveform of the first control signal EM1 is the same as the active level waveform of the second control signal EM2, and within one frame, the start time of the inactive level of the first control signal EM1 is later than the start time of the active level of the second control signal EM2. When the second control signal EM2 is multiplexed as the third control signal EM3, the first control signal EM1 can be multiplexed as the third control signal EM3, or the active level waveform of the first control signal EM1 is the same as the active level waveform of the third control signal EM3, and within one frame, the start time of the inactive level of the first control signal EM1 is later than the start time of the active level of the third control signal EM3, that is, the start time of the inactive level of the third control signal EM3 precedes the start time of the inactive level of the first control signal EM1, thereby enabling the third control signal EM3 to control the second emission control module 190 to turn off before or at the time when the first control signal EM1 controls the first emission control module 160 to turn off. Similarly, the current path between the second terminal of the driving module 110 and the light-emitting device D1 can be cut off through the second light emission control module 190, while reducing the wiring of the display panel, which is beneficial for improving the pixel density of the display panel. Moreover, the first control signal EM1 and the third control signal EM3 are provided by the same set of gate driving circuits, which can reduce the number of gate driving circuits required for the pixel circuit, thereby enabling a narrow bezel design for the display panel. FIGS. 17 to 19 exemplarily show the fifth transistor T5 and the seventh transistor T7 as P-type transistors, and the sixth transistor T6 as an N-type transistor. In other embodiments, FIG. 20 is a schematic structural diagram of another pixel circuit provided by an embodiment of the present disclosure. As shown in FIG. 20, the fifth transistor T5 and the seventh transistor T7 can also be set as N-type transistors, and the sixth transistor T6 as a P-type transistor. In this case, the high level of the first control signal EM1, the second control signal EM2, and the

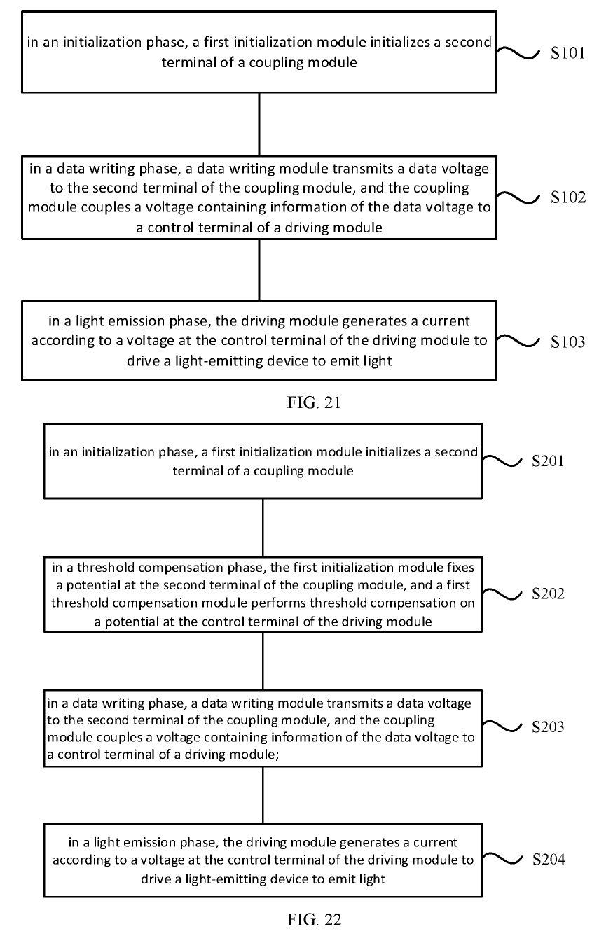

third control signal EM3 can be adjusted to a low level, and the low level can be adjusted to a high level according to the type of transistors, which can also ensure the normal operation of the pixel circuit, and will not be elaborated upon here. An embodiment of the present disclosure also provides a driving method for a pixel circuit, used for driving the pixel circuit provided in any of the above embodiments. FIG. 21 is a schematic flowchart of a driving method for a pixel circuit provided by an embodiment of the present disclosure. As shown in FIG. 21, the driving method for the pixel circuit includes: S101, in an initialization phase, a first initialization module initializes the second terminal of a coupling module; S102, in a data writing phase, a data writing module transmits a data voltage to the second terminal of the coupling module, and the coupling module couples a voltage containing data voltage information to the control terminal of a driving module; S103, in a light emission phase, the driving module generates a current based on the voltage at the control terminal of the driving module to drive a light-emitting device to emit light. In this embodiment, during the data writing phase, the data writing module transmits the data voltage to the second terminal of the coupling module, and the coupling module directly couples the voltage containing data voltage information to the control terminal of the driving module, and the potential at the control terminal of the driving module is only related to the last data voltage provided by the data writing module. At this time, setting the waveform of the active level of the first scan signal to be the same as the waveform of the active level of the second scan signal not only ensures the normal operation of the pixel circuit but also allows the first scan signal and the second scan signal to be provided by the same set of gate driving circuits, thereby reducing the number of gate driving circuits required for the pixel circuit, which in turn reduces the space occupied by the gate driving circuits in the bezel of the display panel, facilitating a narrow bezel design of the display panel. In some embodiments, the pixel circuit further includes a first threshold compensation module, with a first terminal of the first threshold compensation module connected to a first terminal of the driving module, a second terminal of the first threshold compensation module connected to a first terminal of the coupling module, and a control terminal of the first threshold compensation module used for inputting a second scan signal. FIG. 22 is a schematic flowchart of another driving method for a pixel circuit provided by an embodiment of the present disclosure. As shown in FIG. 22, the driving method for the pixel circuit includes: S201, in an initialization phase, a first

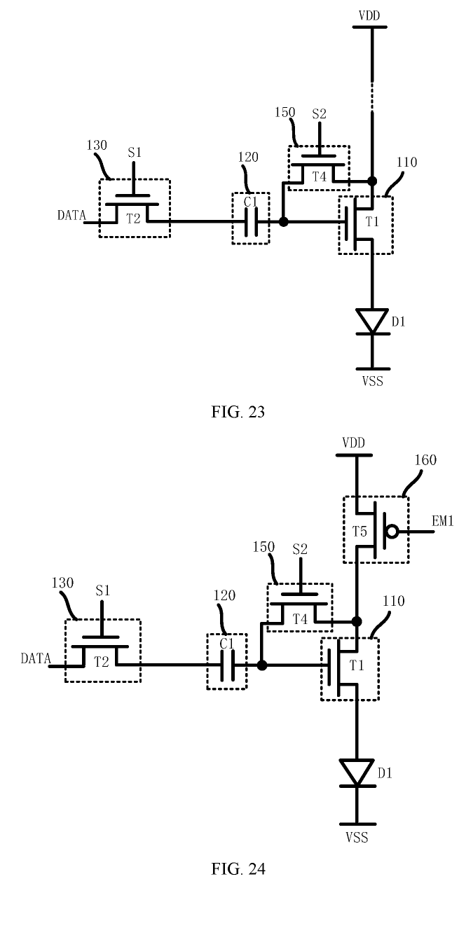

initialization module initializes the second terminal of a coupling module; S202, in a threshold compensation phase, the first initialization module fixes the potential at the second terminal of the coupling module, and the first threshold compensation module performs threshold compensation on the potential at the control terminal of the driving module. S203, in a data writing phase, a data writing module transmits a data voltage to the second terminal of the coupling module, and the coupling module couples a voltage containing data voltage information to the control terminal of the driving module; S204, in a light emission phase, the driving module generates a current based on the voltage at the control terminal of the driving module to drive a light-emitting device to emit light. An embodiment of the present disclosure also provides a pixel circuit. FIG. 23 is a schematic structural diagram of another pixel circuit provided by an embodiment of the present disclosure. As shown in FIG. 23, the pixel circuit includes: a driving module 110; a coupling module 120, with a first terminal of the coupling module 120 connected to a control terminal of the driving module 110; a data writing module 130, with a first terminal of the data writing module 130 connected to a second terminal of the coupling module 120, and a control terminal of the data writing module 130 used for inputting a first scan signal S1; a first threshold compensation module 150, with a first terminal of the first threshold compensation module 150 connected to the control terminal of the driving module 110, a second terminal of the first threshold compensation module 150 connected to a first terminal of the driving module 110, and a control terminal of the first threshold compensation module 150 used for inputting a second scan signal S2; the waveform of the active level of the first scan signal S1 is the same as the waveform of the active level of the second scan signal S2, and within one frame, the start time of the active level of the first scan signal S1 is later than the end time of the active level of the second scan signal S2.

In one embodiment, when the second scan signal S2 is at an active level, the first threshold compensation module 150 connects the first terminal and the control terminal of the driving module 110. When the driving module 110 is turned on, the voltage at the control terminal of the driving module 110 can be discharged through the first threshold compensation module 150 and the driving module 110 until the driving module 110 is turned off, enabling the driving module 110 to achieve threshold voltage compensation via the first threshold compensation module 150. This avoids the influence of the device characteristics

of the driving module 110 on the luminance of the light-emitting device D1, thereby improving the luminance uniformity of the display panel. After the second scan signal S2 transitions from the active level to an inactive level, the first scan signal S1 becomes active, and the data writing module 130 can provide a data voltage to the second terminal of the coupling module 120, achieving the writing of the data voltage. The coupling module 120 has a coupling effect, which can directly couple the voltage containing the data voltage information to the control terminal of the driving module 110. The driving module 110 can generate a current based on the voltage at the control terminal to drive the light-emitting device to emit light. Due to the direct coupling effect of the coupling module 120, the potential at the control terminal of the driving module 110 is only related to the last data voltage provided by the data writing module 130, thereby allowing the timing for the data writing module 130 to provide the data voltage to be flexibly set. At this time, by setting the waveform of the active level of the first scan signal S1 to be the same as the waveform of the active level of the second scan signal S2, the first scan signal S1 and the second scan signal S2 can be provided by the same set of gate driving circuits. This can reduce the number of gate driving circuits required for the pixel circuit, thereby reducing the border space occupied by the gate driving circuits in the display panel, which is beneficial for achieving a narrow-bezel design of the display panel. Simultaneously, since the waveform of the active level of the second scan signal S2 is the same as that of the first scan signal S1, the time during which the data writing module 130 provides the data voltage DATA is the same as the time during which the first threshold compensation module 150 performs threshold compensation on the voltage at the control terminal of the driving module 110, ensuring the reliability of the threshold compensation for the driving module 110. In this embodiment, by setting the waveform of the active level of the first scan signal to be the same as that of the second scan signal, and within one frame, the start time of the active level of the first scan signal is later than the end time of the active level of the second scan signal, the first scan signal and the second scan signal can be provided by the same set of gate driving circuits. This can reduce the number of gate driving circuits required for the pixel circuit, thereby reducing the border space occupied by the gate driving circuits in the display panel, which is beneficial for achieving a narrow-bezel design of the display panel. Simultaneously, the time during which the data writing module provides the data voltage is the same as the time during which the

first threshold compensation module performs threshold compensation on the voltage at the control terminal of the driving module, ensuring the reliability of the threshold compensation for the driving module. Continuing to refer to FIG. 23, the first terminal of the driving module 110 is connected to the first power line VDD, the second terminal of the driving module 110 is connected to the first electrode of the light-emitting device D1, the second electrode of the light-emitting device D1 is connected to the second power line VSS, and the second terminal of the data writing module 130 is used to input the data voltage DATA. Continuing to refer to FIG. 23, the driving module 110 includes a first transistor T1. The gate of the first transistor T1 is connected to the first terminal of the coupling module 120 and the first terminal of the first threshold compensation module 150. The first terminal of the first transistor T1 is connected to the first power line VDD, and the second terminal of the first transistor T1 is connected to the first electrode of the light-emitting device D1. Continuing to refer to FIG. 23, the first transistor T1 is an N-type transistor. Continuing to refer to FIG. 23, the data writing module 130 includes a second transistor T2. The first terminal of the second transistor T2 is connected to the second terminal of the coupling module 120, the gate of the second transistor T2 is used to input the first scan signal S1, and the second terminal of the second transistor T2 is used to input the data voltage DATA. Continuing to refer to FIG. 23, the second transistor T2 is an N-type transistor or a P-type transistor. Continuing to refer to FIG. 23, the coupling module 120 includes a first capacitor C1. The first terminal of the first capacitor C1 is connected to the control terminal of the driving module 110, and the second terminal of the first capacitor C1 is connected to the first terminal of the data writing module 130. Continuing to refer to FIG. 23, the first threshold compensation module 150 includes a fourth transistor T4. The gate of the fourth transistor T4 is used to input the second scan signal S2, the first terminal of the fourth transistor T4 is connected to the control terminal of the driving module 110, and the second terminal of the fourth transistor T4 is connected to the first terminal of the driving module 110. Continuing to refer to FIG. 23, the second transistor T2 and the fourth transistor T4 are transistors of the same type. FIG. 24 is a schematic structural diagram of another pixel circuit provided by an embodiment of the present disclosure. As shown in FIG. 24, the pixel circuit further includes: a first light emission control module 160. The first terminal of the first light emission control module 160 is connected to the first power line VDD, the

second terminal of the first light emission control module 160 is connected to the first terminal of the driving module 110, and the control terminal of the first light emission control module 160 is used to input a first control signal EM1. The start time of the inactive level of the first control signal EM1 is later than the start time of the active level of the second scan signal S2. Continuing to refer to FIG. 24, the first light emission control module 160 includes a fifth transistor T5. The first terminal of the fifth transistor T5 is connected to the first power line VDD, the second terminal of the fifth transistor T5 is connected to the first terminal of the driving module 110, and the gate of the fifth transistor T5 is used to input the first control signal EM1.

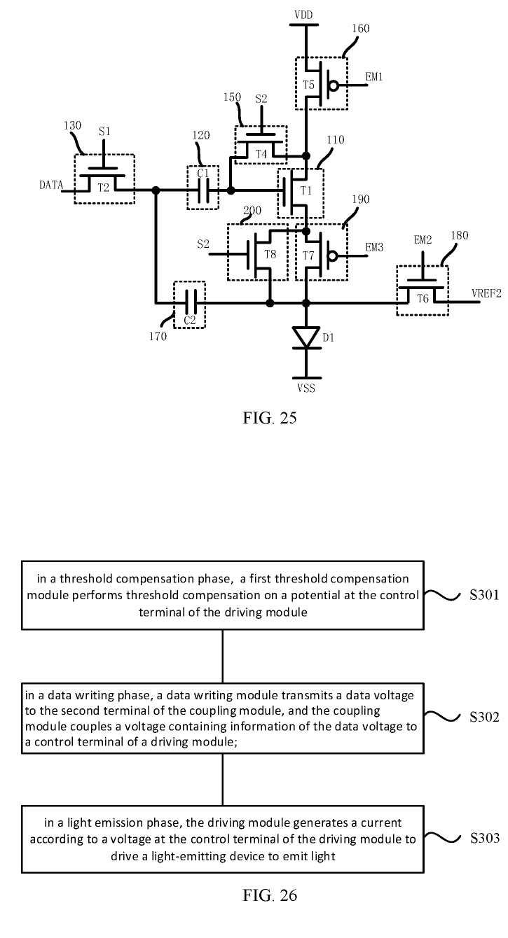

FIG. 25 is a schematic structural diagram of another pixel circuit provided by an embodiment of the present disclosure. As shown in FIG. 25, the pixel circuit further includes:

a storage module 170, a first terminal of the storage module 170 is connected to a first terminal or a second terminal of a coupling module 120, and a second terminal of the storage module 170 is connected to a second terminal of a driving module 110.

a second initialization module 180, a first terminal of the second initialization module 180 is configured to receive a second initialization voltage VREF2, a second terminal of the second initialization module 180 is connected to the second terminal of the storage module 170 and a first electrode of a light-emitting device D1, and a control terminal of the second initialization module 180 is configured to receive a second control signal EM2.

A first control signal EM1 is multiplexed as the second control signal EM2; or, an active level waveform of the first control signal EM1 is the same as an active level waveform of the second control signal EM2, and within one frame, a start time of an inactive level of the first control signal EM1 is later than a start time of the active level of the second control signal EM2.

In one embodiment, FIG. 25 exemplarily shows that the first terminal of the storage module 170 is connected to the second terminal of the coupling module 120. Meanwhile, the active level waveform of the first control signal EM1 is the same as the active level waveform of the second control signal EM2, and within one frame, the start time of the inactive level of the first control signal EM1 is later than the start time of the active level of the second control signal EM2. In other embodiments, it may also be configured that the first terminal of the storage module 170 is connected to the first terminal of the coupling module 120, and/or the first control signal EM1 is multiplexed as the second control signal EM2, which is not limited herein.

Continuing to refer to FIG. 25, the storage module 170 includes a second capacitor C2, a first plate of the second capacitor C2 is connected to the first terminal or the second terminal of the coupling module 120, and a second plate of the second capacitor C2 is connected to the second terminal of the second initialization module 180 and the first electrode of the light-emitting device D1.

Continuing to refer to FIG. 25, the second initialization module 180 includes a sixth transistor T6, a first terminal of the sixth transistor T6 is configured to receive the second initialization voltage VREF2, a second terminal of the sixth transistor T6 is connected to the first electrode of the light-emitting device D1 and the second terminal of the storage module 170, and a gate of the sixth transistor T6 is configured to receive the second control signal EM2.

Continuing to refer to FIG. 25, the fifth transistor T5 is a P-type transistor, the sixth transistor T6 is an N-type transistor, a start time of a high level of the first control signal EM1 is later than a start time of a high level of the second control signal EM2, or the first control signal EM1 is multiplexed as the second control signal EM2.

In one embodiment, FIG. 25 exemplarily shows that the first control signal EM1 and the second control signal EM2 are different control signals. In this case, it may be configured that the start time of the high level of the first control signal EM1 is later than the start time of the high level of the second control signal EM2. In other embodiments, it may also be configured that the first control signal EM1 is multiplexed as the second control signal EM2, which is not limited herein.

In some embodiments, it may also be configured that the fifth transistor T5 is an N-type transistor, the sixth transistor T6 is a P-type transistor, a start time of a low level of the first control signal EM1 is later than a start time of a low level of the second control signal EM2, or the first control signal EM1 is multiplexed as the second control signal EM2.

Continuing to refer to FIG. 25, the pixel circuit further includes:

a second light emission control module 190, a control terminal of the second light emission control module 190 is configured to receive a third control signal EM3, a first terminal of the second light emission control module 190 is connected to the second terminal of the driving module 110, and a second terminal of the second light emission control module 190 is connected to the first electrode of the light-emitting device D1; a start time of an inactive level of the third control signal EM3 is earlier than a start time of an inactive level of the first control signal EM1, or the start time of the inactive level of the third control signal EM3 is the same as the start time of the inactive level of the first control signal EM1.

a second threshold compensation module 200, a control terminal of the second threshold compensation module 200 is configured to receive a second scan signal S2, a first terminal of the second threshold compensation module 200 is connected to the second terminal of the driving module 110, and a second terminal of the second threshold compensation module 200 is connected to the first electrode of the light-emitting device D1.

Continuing to refer to FIG. 25, the second light emission control module 190 includes a seventh transistor T7; a gate of the seventh transistor T7 is configured to receive the third control signal EM3, a first terminal of the seventh transistor T7 is connected to the second terminal of the driving module 110, and a second terminal of the seventh transistor T7 is connected to the first electrode of the light-emitting device D1.

In some embodiments, the first control signal EM1 or the second control signal EM2 is multiplexed as the third control signal EM3.

Continuing to refer to FIG. 25, the second threshold compensation module 200 includes an eighth transistor T8, a gate of the eighth transistor T8 is configured to receive the second scan signal S2, a first terminal of the eighth transistor T8 is connected to the second terminal of the driving module 110, and a second terminal of the eighth transistor T8 is connected to the first electrode of the light-emitting device D1.

An embodiment of the present disclosure further provides a driving method for a pixel circuit, configured to drive the pixel circuit provided in any of the above embodiments. FIG. 26 is a schematic flowchart of a driving method for a pixel circuit provided by an embodiment of the present disclosure. As shown in FIG. 26, the driving method for the pixel circuit includes:

S301, in a threshold compensation phase, a first threshold compensation module performs threshold compensation on a potential of a control terminal of a driving module.

S302, in a data writing phase, a data writing module transmits a data voltage to a second terminal of a coupling module, and the coupling module couples a voltage containing data voltage information to the control terminal of the driving module;

S303, in a light emission phase, the driving module generates a current according to a voltage at the control terminal of the driving module to drive a light-emitting device to emit light.

In this embodiment, by setting the waveform of the effective level of the first scan signal to be the same as the waveform of the effective level of the second scan signal, and by setting the start time of the effective level of the first scan signal within one frame to be later than the end time of the effective level of the second scan signal, the first scan signal and the second scan signal can be provided by the same set of gate driving circuits. This can reduce the number of gate driving circuits required for the pixel circuit, thereby reducing the border space occupied by the gate driving circuits on the display panel, which is beneficial for achieving a narrow-bezel design of the display panel. At the same time, it ensures that the threshold compensation phase and the data writing phase have the same duration, guaranteeing the reliability of the threshold compensation of the driving module.

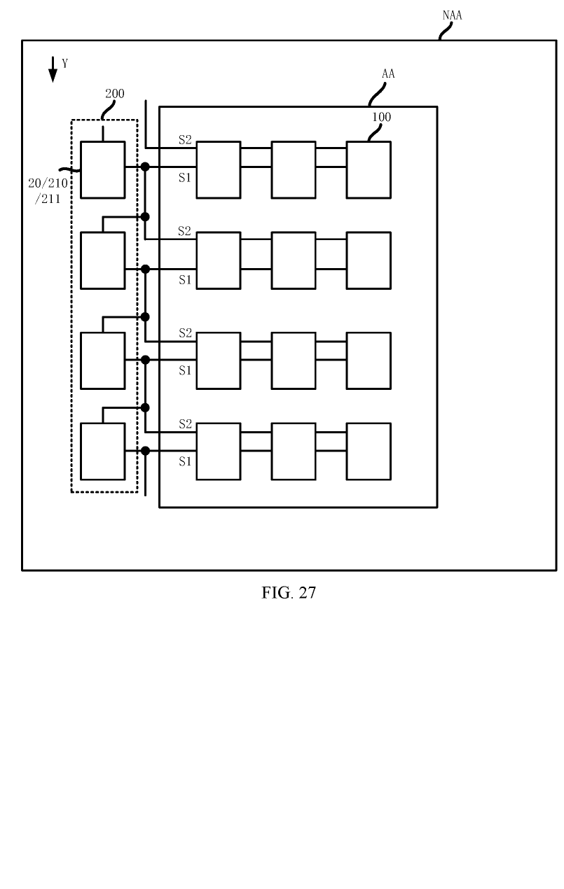

The embodiment of the present disclosure also provides an array substrate. FIG. 27 is a schematic structural diagram of an array substrate provided by an embodiment of the present disclosure. As shown in FIG. 27, the array substrate includes at least one set of cascaded gate driving circuits 200 and the pixel circuit 100 provided in any embodiment of the present disclosure. The first scan signal and the second scan signal in the pixel circuit 100 are provided by the same set of gate driving circuits 200.

In one embodiment, FIG. 27 exemplarily shows that the array substrate includes pixel circuits 100 arranged in an array. The same set of gate driving circuits 200 includes multiple stages of cascaded gate driving circuits 20. Each stage of the gate driving circuit 20 is connected to at least one row of pixel circuits 100 and is used to provide gate driving signals to at least one row of pixel circuits 100. Among these, the gate driving signals may include scan signals and control signals. When the waveform of the effective level of the first scan signal S1 of the pixel circuit 100 is the same as the waveform of the effective level of the second scan signal S2, and within one frame, the start time of the effective level of the first scan signal S1 is later than the end time of the effective level of the second scan signal S2, different stages of the same set of gate driving circuits 200 can simultaneously provide the first scan signal S1 and the second scan signal S2 to the pixel circuit 100. This allows the scan signals of the pixel circuit 100 to be provided by one set of gate driving circuits 200, reducing the number of gate driving circuits 20 required for the pixel circuit 100, thereby decreasing the border space occupied by the gate driving circuits 20 on the display panel, which is beneficial for achieving a narrow-bezel design of the display panel. For example, as shown in FIG. 27, in one set of gate driving circuits 200, the first-stage gate driving circuit 20 is used to provide the second scan signal S2 to the first row of pixel circuits 100, and the second-stage gate driving circuit 20 is used to provide the first scan signal S1 to the first row of pixel circuits 100 while also providing the second scan signal S2 to the second row of pixel circuits 100. By analogy, the same set of gate driving circuits 200 simultaneously provides the first scan signal S1 and the second scan signal S2 to the pixel circuits 100.

In this embodiment, when the waveform of the effective level of the first scan signal of the pixel circuit is the same as the waveform of the effective level of the second scan signal, and within one frame, the start time of the effective level of the first scan signal is later than the end time of the effective level of the second scan signal, different stages of the same set of gate driving circuits can simultaneously provide the first scan signal and the second scan signal to the pixel circuit. This allows the scan signals of the pixel circuit to be provided by one set of gate driving circuits, reducing the number of gate driving circuits required for the pixel circuit, thereby decreasing the border space occupied by the gate driving circuits on the display panel, which is beneficial for achieving a narrow-bezel design of the display panel.

For example, continuing to refer to FIG. 27, at least one set of gate driving circuits 200 includes multiple stages of cascaded scan circuits 210. The i-th stage scan circuit 210 is used to provide the first scan signal S1 to the i-th row of pixel circuits 100, and the (i-1)-th stage scan circuit 210 is used to provide the second scan signal S2 to the i-th row of pixel circuits 100, where i is a positive integer greater than or equal to 2.

In one embodiment, the multiple stages of scan circuits 210 can sequentially shift and output scan signals of different stages, causing the effective level of the scan signal of the next stage to be output with a delay relative to the effective level of the scan signal of the previous stage. By setting the i-th stage scan circuit 210 to provide the first scan signal S1 to the i-th row of pixel circuits 100 and the (i-1)-th stage scan circuit 210 to provide the second scan signal S2 to the i-th row of pixel circuits 100, it can be ensured that the waveform of the effective level of the first scan signal S1 is the same as the waveform of the effective level of the second scan signal S2 within the same row of pixel circuits 100. Moreover, within one frame, the effective level of the first scan signal S1 is output with a delay relative to the effective level of the second scan signal S2, meaning the start time of the effective level of the first scan signal S1 is later than the end time of the effective level of the second scan signal S2. This allows one set of scan circuits 210 to drive the pixel circuits 100 to function normally, reducing the number of scan circuits 210 required for the pixel circuits 100, thereby decreasing the border space occupied by the scan circuits 210 on the display panel, which is beneficial for achieving a narrow-bezel design of the display panel.

Continuing to refer to FIG. 27, the display panel includes a display area AA and a non-display area NAA, with the non-display area NAA at least partially surrounding the display area AA. The pixel circuits 100 are disposed in the display area AA, and the gate driving circuits 200 are disposed in the non-display area NAA.

In one embodiment, FIG. 27 exemplarily shows the pixel circuits 100 arranged in an array within the display area AA. Along the column direction Y of the pixel circuit arrangement, the non-display area NAA is disposed on both sides of the display area AA, allowing the gate driving circuits 200 to provide scan signals to at least one row of pixel circuits 100.

For example, the display area AA includes pixel circuits 100 arranged in an array. Along the column direction Y of the pixel circuits 100, the scan circuits 210 are disposed on at least one side of the display area AA, enabling the scan circuits 210 to provide scan signals to one row of pixel circuits 100. Among these, the scan signals include the first scan signal S1 and the second scan signal S2. In this case, the array substrate includes one set of scan circuits 210, which are used to provide the first scan signal S1 and the second scan signal S2 to different rows of pixel circuits 100.

Continuing to refer to FIG. 27, each stage of the scan circuit 210 includes a first scan circuit 211. Along the column direction Y of the pixel circuits 100, the first scan circuit 211 is disposed on one side of the display area AA, and the first scan circuit 211 is configured to provide a first scan signal S1 or a second scan signal S2 to a row of pixel circuits 100.

In one embodiment, FIG. 27 exemplarily shows that the scan circuit 210 includes only the first scan circuit 211. Each stage of the first scan circuit 211 is configured to provide the first scan signal S1 to the pixel circuits 100 in the same row and simultaneously provide the second scan signal S2 to the pixel circuits 100 in the next row, and the scan signal for each row of pixel circuits 100 is driven from a single side. In this case, the scan circuit 210 can be disposed only in the non-display area NAA on one side of the display area AA, which is beneficial for achieving a narrow bezel design for the array substrate. Exemplarily, this array substrate can be applied as a display panel for display devices such as watches.

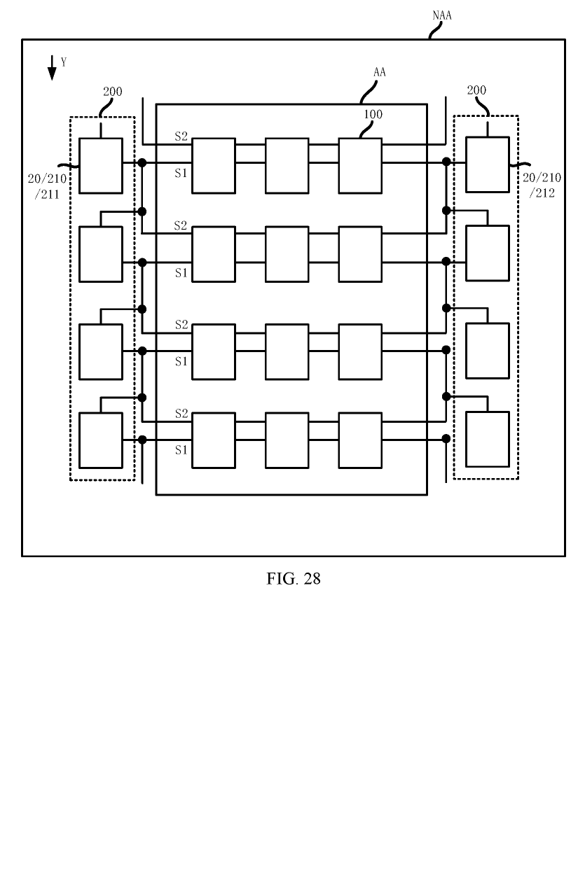

FIG. 28 is a schematic structural diagram of another array substrate provided by an embodiment of the present disclosure. As shown in FIG. 28, each stage of the scan circuit 210 further includes a second scan circuit 212. Along the column direction Y of the pixel circuits 100, the second scan circuit 212 is disposed on a side of the display area AA away from the first scan circuit 211. The second scan circuit 212 is configured to provide the first scan signal S1 or the second scan signal S2 to the pixel circuits 100 connected to the corresponding first scan circuit 211 of the same stage.

In one embodiment, within the same stage of the scan circuit 210, the first scan circuit 211 and the second scan circuit 212 can be disposed on two sides of the display area AA, respectively. Furthermore, within the same stage of the scan circuit 210, the first scan circuit 211 and the second scan circuit 212 are connected to the pixel circuits 100 of the same row and are configured to provide the first scan signal S1 or the second scan signal S2 to the pixel circuits 100 of the same row, thereby achieving bilateral driving for each row of pixel circuits 100. This is beneficial for improving the consistency of scan signals for the pixel circuits 100 in the same row, and further beneficial for improving the brightness uniformity of the display panel. In one embodiment, as shown in FIG. 28, the first scan circuit 211 of the i-th stage provides the first scan signal S1 sequentially from the first column to the last column to the pixel circuits 100 of the i-th row, and the second scan circuit 212 of the i-th stage provides the first scan signal S1 sequentially from the last column to the first column to the pixel circuits 100 of the i-th row. The first scan circuit 211 of the (i-1)-th stage provides the second scan signal S2 sequentially from the first column to the last column to the pixel circuits 100 of the i-th row, and the second scan circuit 212 of the (i-1)-th stage provides the second scan signal S2 sequentially from the last column to the first column to the pixel circuits 100 of the i-th row. Exemplarily, this array substrate can be applied as a display panel for display devices such as mobile phones.

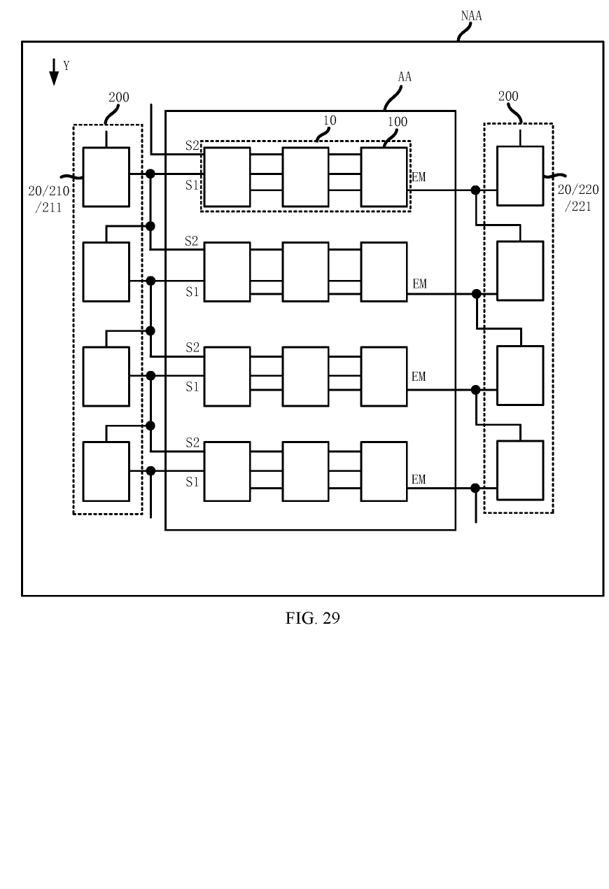

FIG. 29 is a schematic structural diagram of another array substrate provided by an embodiment of the present disclosure. As shown in FIG. 29, the pixel circuits 100 are divided into multiple groups, each group of pixel circuits 100 includes at least one row of pixel circuits 100. At least one group of gate driver circuits 200 further includes multiple stages of light emission control circuits 220 connected in cascade. The light emission control circuit 220 of the (i+1)-th stage is configured to provide a first control signal EM1 to the pixel circuits 100 of the i-th group, and the light emission control circuit 220 of the i-th stage is configured to provide a second control signal EM2 to the pixel circuits 100 of the i-th group. In one embodiment, each stage of the light emission control circuit 220 is configured to provide the first control signal EM1 and the second control signal EM2 to each group of pixel circuits 100. Here, i is a positive integer greater than or equal to 1.

In one embodiment, the multiple stages of light emission control circuits 220 can sequentially shift and output control signals of different stages, and the effective level of the control signal of the next stage is delayed and shifted relative to the effective level of the control signal of the previous stage. FIG. 29 exemplarily shows that each group of pixel circuits 100 includes one row of pixel circuits 100. When the start time of the inactive level of the first control signal EM1 of the pixel circuit 100 is later than the start time of the active level of the second control signal EM2, the light emission control circuit 220 of the (i+1)-th stage is configured to provide the first control signal EM1 to the pixel circuits 100 of the i-th row, and the light emission control circuit 220 of the i-th stage is configured to provide the second control signal EM2 to the pixel circuits 100 of the i-th row. When the first control signal EM1 of the pixel circuit 100 is multiplexed as the second control signal EM2, the light emission control circuit 220 of the i-th stage is configured to provide the first control signal EM1 and the second control signal EM2 to the pixel circuits 100 of the i-th row (as shown in FIG. 29, the same stage of light emission control circuit 220 outputs a control signal EM, which serves as the first control signal EM1 and the second control signal EM2 for the pixel circuit 100). In this case, the same group of light emission control circuits 220 can be used to provide control signals to the pixel circuits 100, reducing the number of light emission control circuits 220 required by the pixel circuits 100, and thereby reducing the bezel space occupied by the light emission control circuits 220 on the display panel, which is beneficial for achieving a narrow bezel design for the display panel.

Continuing to refer to FIG. 29, along the column direction Y of the pixel circuits 100, the light emission control circuit 220 is disposed on at least one side of the display area AA.

In one embodiment, FIG. 29 exemplarily shows that the light emission control circuit 220 is disposed in the non-display area NAA on one side of the display area AA, enabling the light emission control circuit 220 to provide control signals to at least one row of pixel circuits 100 within a group of pixel circuits 100. Here, the control signals include the first control signal EM1 and the second control signal EM2. In this case, the array substrate includes one group of light emission control circuits 220, configured to provide the first control signal EM1 and the second control signal EM2 to pixel circuits 100 of different rows. This can reduce the bezel space occupied by the light emission control circuits 220 on the display panel, which is beneficial for achieving a narrow bezel design for the display panel.

Continuing to refer to FIG. 29, each stage of the light emission control circuit 220 includes a first light emission control circuit 221. Along the column direction Y of the pixel circuits 100, the first light emission control circuit 221 is disposed on one side of the display area AA, and the first light emission control circuit 221 is configured to provide control signals to a group of pixel circuits 100.

In one embodiment, FIG. 29 exemplarily shows that each stage of the light emission control circuit 220 includes only the first light emission control circuit 221. Each stage of the first light emission control circuit 221 is configured to provide a control signal to the pixel circuit 100, and the control signal for each row of pixel circuits 100 is driven unilaterally. In this case, the light emission control circuit 220 can be disposed only in the non-display area NAA on one side of the display area AA, which is beneficial for achieving a narrow bezel design for the array substrate. Exemplarily, the array substrate can be applied as a display panel for display devices such as watches.

Continuing to refer to FIG. 29, along the column direction Y of the pixel circuits 100, the first light emission control circuit 221 and the first scan circuit 211 are respectively disposed on two sides of the display area AA.

In one embodiment, referring to FIG. 29, when the scan circuit 210 of the array substrate includes only the first scan circuit 211 and the light emission control circuit 220 includes only the first light emission control circuit 221, along the column direction Y of the pixel circuits 100, the first light emission control circuit 221 and the first scan circuit 211 can be respectively disposed on two sides of the display area AA. This arrangement can fully utilize the space in the non-display areas NAA on both sides of the display area AA, which is beneficial for achieving a narrow bezel design for the display panel.

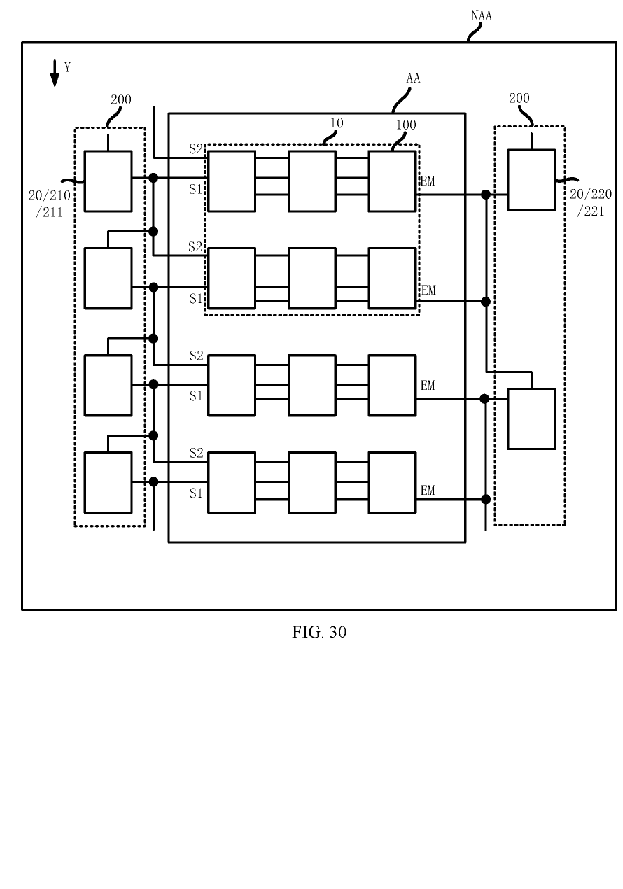

In some embodiments, each group of pixel circuits 10 may include multiple rows of pixel circuits 100. Exemplarily, FIG. 30 is a schematic structural diagram of another array substrate provided by an embodiment of the present disclosure. As shown in FIG. 30, each group of pixel circuits 10 may include two rows of pixel circuits 100. In this case, each stage of the light emission control circuit 220 provides control signals to two rows of pixel circuits 100. Exemplarily, as shown in FIG. 30, the first group of pixel circuits 10 includes the first row of pixel circuits 100 and the second row of pixel circuits 100, and the second group of pixel circuits 10 includes the third row of pixel circuits 100 and the fourth row of pixel circuits 100. When the first control signal EM1 of the pixel circuit 100 is multiplexed as the second control signal EM2, the first-stage light emission control circuit 220 provides the control signal EM to the first row of pixel circuits 100 and the second row of pixel circuits 100, and the second-stage light emission control circuit 220 provides the control signal EM to the third row of pixel circuits 100 and the fourth row of pixel circuits 100. When the start time of the invalid level of the first control signal EM1 of the pixel circuit 100 is later than the start time of the valid level of the second control signal EM2, the first-stage light emission control circuit 220 provides the second control signal EM2 to the first row of pixel circuits 100 and the second row of pixel circuits 100, and the second-stage light emission control circuit 220 provides the first control signal EM1 to the first row of pixel circuits 100 and the second row of pixel circuits 100, while also providing the second control signal EM2 to the third row of pixel circuits 100 and the fourth row of pixel circuits 100.

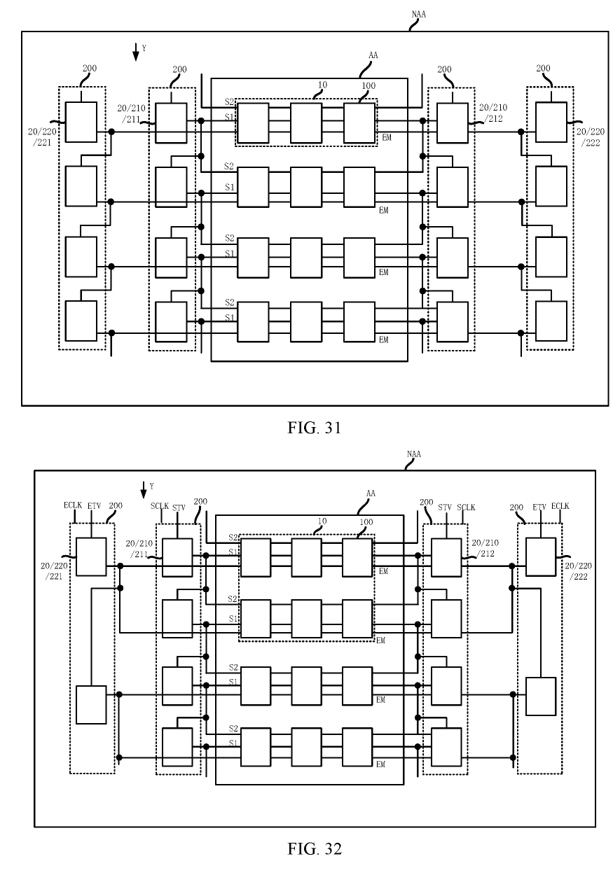

FIG. 31 is a schematic structural diagram of another array substrate provided by an embodiment of the present disclosure. As shown in FIG. 31, each stage of the light emission control circuit 220 further includes a second light emission control circuit 222. Along the column direction Y of the pixel circuits 100, the second light emission control circuit 222 is disposed on the side of the display area AA away from the first light emission control circuit 221. The second light emission control circuit 222 is configured to provide control signals to the pixel circuits 100 connected to the first light emission control circuit 221 of the same stage.

In one embodiment, within the same stage of the light emission control circuit 220, the first light emission control circuit 221 and the second light emission control circuit 222 can be respectively disposed on two sides of the display area AA. Moreover, within the same stage of the light emission control circuit 220, the first light emission control circuit 221 and the second light emission control circuit 222 are connected to the pixel circuits 100 of the same row and are used to provide control signals to the pixel circuits 100 of the same row, achieving bilateral driving of the control signals for each row of pixel circuits 100. This is beneficial for improving the consistency of control signals for the same row of pixel circuits 100, thereby contributing to improved brightness uniformity of the display panel.

Exemplarily, when the start time of the invalid level of the first control signal EM1 of the pixel circuit 100 is later than the start time of the valid level of the second control signal EM2, the first light emission control circuit 221 of the (i+1)-th stage provides the first control signal EM1 to the pixel circuits 100 of the i-th group sequentially from the first column to the last column, and the second light emission control circuit 222 of the (i+1)-th stage provides the second control signal EM2 to the pixel circuits 100 of the i-th group sequentially from the last column to the first column. The first light emission control circuit 221 of the i-th stage is used to provide the second control signal EM2 to the pixel circuits 100 of the i-th group sequentially from the first column to the last column, and the second light emission control circuit 222 of the i-th stage is used to provide the second control signal EM2 to the pixel circuits 100 of the i-th group sequentially from the last column to the first column. When the first control signal EM1 of the pixel circuit 100 is multiplexed as the second control signal EM2, the first light emission control circuit 221 of the i-th stage is used to provide the control signal EM to the pixel circuits 100 of the i-th group sequentially from the first column to the last column. This control signal EM serves as both the first control signal EM1 and the second control signal EM2 for the pixel circuit 100. The second light emission control circuit 222 of the i-th stage is used to provide the control signal EM to the pixel circuits 100 of the i-th group sequentially from the last column to the first column, achieving bilateral driving of the control signals for the pixel circuits 100 and improving the brightness uniformity of the display panel. Exemplarily, the array substrate can be applied as a display panel for display devices such as mobile phones.

Continuing to refer to FIG. 31, the scan circuit 210 includes a first scan circuit 211 and a second scan circuit 212. In this case, the first scan circuit 211 and the first light emission control circuit 221 are disposed in the non-display area NAA on one side of the display area AA, with the first light emission control circuit 221 disposed on the side of the first scan circuit 211 away from the display area AA. The second scan circuit 212 and the second light emission control circuit 222 are disposed in the non-display area NAA on the other side of the display area AA, with the second light emission control circuit 222 disposed on the side of the second scan circuit 212 away from the display area AA.

In some embodiments, each group of pixel circuits 10 may include multiple rows of pixel circuits 100. For example, FIG. 32 is a schematic structural diagram of another array substrate provided by an embodiment of the present disclosure. As shown in FIG. 32, each group of pixel circuits 10 may include two rows of pixel circuits 100. In this case, each stage of light emission control circuit 220 provides control signals for two rows of pixel circuits 100. Each stage of light emission control circuit 220 includes a first light emission control circuit 221 and a second light emission control circuit 222. Both the first light emission control circuit 221 and the second light emission control circuit 222 provide control signals for two rows of pixel circuits 100, achieving bilateral driving of the pixel circuits 100. For example, as shown in FIG. 32, the first group of pixel circuits 10 includes the first row of pixel circuits 100 and the second row of pixel circuits 100, and the second group of pixel circuits 10 includes the third row of pixel circuits 100 and the fourth row of pixel circuits 100. When the first control signal EM1 of the pixel circuit 100 is multiplexed as the second control signal EM2, the first light emission control circuit 221 of the first stage provides the control signal EM sequentially from the first column to the last column for the first row of pixel circuits 100 and the second row of pixel circuits 100, and the second light emission control circuit 222 of the first stage provides the control signal EM sequentially from the last column to the first column for the first row of pixel circuits 100 and the second row of pixel circuits 100. The first light emission control circuit 221 of the second stage provides the control signal EM sequentially from the first column to the last column for the third row of pixel circuits 100 and the fourth row of pixel circuits 100, and the second light emission control circuit 222 of the second stage provides the control signal EM sequentially from the last column to the first column for the third row of pixel circuits 100 and the fourth row of pixel circuits 100. When the start time of the invalid level of the first control signal EM1 of the pixel circuit 100 is later than the start time of the valid level of the second control signal EM2, the first light emission control circuit 221 of the first stage provides the second control signal EM2 sequentially from the first column to the last column for the first row of pixel circuits 100 and the second row of pixel circuits 100, and the second light emission control circuit 222 of the first stage provides the second control signal EM2 sequentially from the last column to the first column for the first row of pixel circuits 100 and the second row of pixel circuits 100. The first light emission control circuit 221 of the second stage provides the first control signal EM1 sequentially from the first column to the last column for the first row of pixel circuits 100 and the second row of pixel circuits 100, and simultaneously provides the second control signal EM2 sequentially from the first column to the last column for the third row of pixel circuits 100 and the fourth row of pixel circuits 100. The second light emission control circuit 222 of the second stage provides the first control signal EM1 sequentially from the last column to the first column for the first row of pixel circuits 100 and the second row of pixel circuits 100, and simultaneously provides the second control signal EM2 sequentially from the last column to the first column for the third row of pixel circuits 100 and the fourth row of pixel circuits 100. Continuing to refer to FIG. 32, the array substrate further includes a first start signal line STV, a second start signal line ETV, a first clock signal line SCLK, and a second clock signal line ELCK. The first start signal line STV and the first clock signal line SCLK are connected to the scan circuit 210; the second start signal line ETV and the second clock signal line ECLK are connected to the light emission control circuit 220; the valid level of the second start signal provided by the second start signal line ETV is opposite to the valid level of the first control signal EM1, and the first start signal provided by the first start signal line STV precedes the second start signal; and/or, the first clock signal provided by the first clock signal line SCLK precedes the second clock signal provided by the second clock signal line ECLK. In one embodiment, the first start signal and the first clock signal can control the operating state of the scan circuit 210, thereby adjusting the timing of the scan signal by adjusting the timing of the first start signal and the first clock signal. The second start signal and the second clock signal can control the operating state of the light emission control circuit 220, thereby adjusting the timing of the control signal by adjusting the timing of the second start signal and the second clock signal. The valid level of the second start signal corresponds to the invalid level of the first control signal EM1. When the valid level of the first control signal EM1 is low, the valid level of the second start signal is high. By setting the first start signal provided by the first start signal line STV to precede the second start signal, and/or setting the first clock signal provided by the first clock signal line SCLK to precede the second clock signal provided by the second clock signal line ECLK, the valid level of the scan signal provided by the scan circuit 210 in one frame precedes the invalid level of the control signal provided by the same stage of the light emission control circuit 220. This ensures that the start time of the invalid level of the first control signal is later than the start time of the valid level of the second scan signal. During the initialization phase of the pixel circuit 100, the first light emission control module and the first threshold compensation module can initialize the voltage at the control terminal of the driving module. Note that the above are only preferred embodiments of the present disclosure and the technical principles applied. Those skilled in the art will understand that the present disclosure is not limited to the specific embodiments described herein, and various changes, readjustments, and substitutions can be made by those skilled in the art without departing from the protection scope of the present disclosure. Therefore, although the present disclosure has been described in detail through the above embodiments, the present disclosure is not limited to the above embodiments. Without departing from the concept of the present disclosure, other equivalent embodiments may be included, and the scope of the present disclosure is determined by the appended claims.

What is claimed is:

1. A pixel circuit, comprising:
a driving module;
a coupling module, a first terminal of the coupling module being connected to a control terminal of the driving module;
a data writing module, a first terminal of the data writing module being connected to a second terminal of the coupling module, a control terminal of the data writing module being configured to receive a first scan signal;
a first initialization module, a first terminal of the first initialization module being connected to the second terminal of the coupling module, a control terminal of the first initialization module being configured to receive a second scan signal;
wherein a waveform of an active level of the first scan signal is identical to a waveform of an active level of the second scan signal, and within one frame, a start time of the active level of the first scan signal is later than an end time of the active level of the second scan signal.

2. The pixel circuit according to claim 1, wherein a first terminal of the driving module is connected to a first power line, a second terminal of the driving module is connected to a first electrode of a light-emitting device, a second electrode of the light-emitting device is connected to a second power line, a second terminal of the data writing module is configured to receive a data voltage, and a second terminal of the first initialization module is configured to receive a first initialization voltage.

3. The pixel circuit according to claim 2, wherein the driving module comprises a first transistor, a gate of the first transistor being connected to the first terminal of the coupling module, a first electrode of the first transistor being connected to the first power line, a second electrode of the first transistor being connected to the first electrode of the light-emitting device;
the first transistor is an N-type transistor;
the data writing module comprises a second transistor, a first electrode of the second transistor being connected to the second terminal of the coupling module, a gate of the second transistor being configured to receive the first scan signal, a second electrode of the second transistor being configured to receive the data voltage;
the second transistor is an N-type transistor or a P-type transistor;
the coupling module comprises a first capacitor, a first electrode of the first capacitor being connected to the control terminal of the driving module, a second electrode of the first capacitor being connected to the first terminal of the data writing module;
the first initialization module comprises a third transistor, a gate of the third transistor being configured to receive the second scan signal, a first electrode of the third transistor being connected to the second terminal of the coupling module, a second electrode of the third transistor being configured to receive the first initialization voltage;
the second transistor and the third transistor are transistors of the same type;
a first power voltage provided by the first power line is reused as the first initialization voltage.

4. The pixel circuit according to claim 1, further comprising:
a first threshold compensation module, a first terminal of the first threshold compensation module being connected to the first terminal of the driving module, a second terminal of the first threshold compensation module being connected to the first terminal of the coupling module, a control terminal of the first threshold compensation module being configured to receive the second scan signal.

5. The pixel circuit according to claim 4, wherein the first threshold compensation module comprises a fourth transistor, a gate of the fourth transistor being configured to receive the second scan signal, a first electrode of the fourth transistor being connected to the first terminal of the driving module, a second electrode of the fourth transistor being connected to the first terminal of the coupling module;
the fourth transistor, the second transistor, and the third transistor are transistors of the same type.

6. The pixel circuit according to claim 1, further comprising:
a first light emission control module, a first terminal of the first light emission control module being connected to a first power line, a second terminal of the first light emission control module being connected to the first terminal of the driving module, a control terminal of the first light emission control module being configured to receive a first control signal; a start time of an inactive level of the first control signal is later than a start time of the active level of the second scan signal.

7. The pixel circuit according to claim 6, wherein the first light emission control module comprises a fifth transistor, a first electrode of the fifth transistor being connected to the first power line, a second electrode of the fifth transistor being connected to the first terminal of the driving module, a gate of the fifth transistor being configured to receive the first control signal.

8. The pixel circuit according to claim 6, further comprising:
a storage module, a first terminal of the storage module being connected to a first terminal or a second terminal of the coupling module, a second terminal of the storage module being connected to a second terminal of the driving module;
a second initialization module, a first terminal of the second initialization module being configured to receive a second initialization voltage, a second terminal of the second initialization module being connected to the second terminal of the storage module and a first electrode of the light-emitting device, a control terminal of the second initialization module being configured to receive a second control signal;
the first control signal is multiplexed as the second control signal;
or,
an effective level waveform of the first control signal is the same as an effective level waveform of the second control signal, and within one frame, a start time of an invalid level of the first control signal is later than a start time of the effective level of the second control signal.

9. The pixel circuit according to claim 8, wherein the storage module comprises a second capacitor, a first plate of the second capacitor being connected to the first terminal or the second terminal of the coupling module, a second plate of the second capacitor being connected to the second terminal of the second initialization module and the first electrode of the light-emitting device;
the second initialization module comprises a sixth transistor, a first electrode of the sixth transistor being configured to receive the second initialization voltage, a second electrode of the sixth transistor being connected to the first electrode of the light-emitting device and the second terminal of the storage module, a gate of the sixth transistor being configured to receive the second control signal;
the fifth transistor is a P-type transistor, the sixth transistor is an N-type transistor, a start time of a high level of the first control signal is later than a start time of a high level of the second control signal, or the first control signal is multiplexed as the second control signal; or
the fifth transistor is an N-type transistor, the sixth transistor is a P-type transistor, a start time of a low level of the first control signal is later than a start time of a low level of the second control signal, or the first control signal is multiplexed as the second control signal.

10. The pixel circuit according to claim 8, wherein a display frame of the pixel circuit comprises at least two sub-frames; one of the sub-frames is a write frame, and the remaining sub-frames are hold frames; a frequency of the first scan signal and a frequency of the second scan signal are the same as a frequency of the display frame, and effective levels of the first scan signal and the second scan signal are located within the write frame; a frequency of the first control signal and a frequency of the second control signal are the same as a frequency of the sub-frames.

11. The pixel circuit according to claim 8, further comprising:
a second light emission control module, a control terminal of the second light emission control module being configured to receive a third control signal, a first terminal of the second light emission control module being connected to the second terminal of the driving module, a second terminal of the second light emission control module being connected to the first electrode of the light-emitting device; a start time of an invalid level of the third control signal precedes a start time of an invalid level of the first control signal, or, the start time of the invalid level of the third control signal is the same as the start time of the invalid level of the first control signal;
a second threshold compensation module, a control terminal of the second threshold compensation module being configured to receive the second scan signal, a first terminal of the second threshold compensation module being connected to the second terminal of the driving module, a second terminal of the second threshold compensation module being connected to the first electrode of the light-emitting device.

12. The pixel circuit according to claim 11, wherein the second light emission control module comprises a seventh transistor; a gate of the seventh transistor is configured to receive the third control signal, a first electrode of the seventh transistor is connected to the second terminal of the driving module, a second electrode of the seventh transistor is connected to the first electrode of the light-emitting device;
the first control signal or the second control signal is multiplexed as the third control signal;
the second threshold compensation module comprises an eighth transistor, a gate of the eighth transistor is configured to receive the second scan signal, a first electrode of the eighth transistor is connected to the second terminal of the driving module, a second electrode of the eighth transistor is connected to the first electrode of the light-emitting device.

13. A driving method for a pixel circuit, for driving the pixel circuit according to claim 1, the driving method for the pixel circuit comprising:
in an initialization phase, a first initialization module initializes a second terminal of a coupling module;
in a data writing phase, a data writing module transmits a data voltage to the second terminal of the coupling module, and the coupling module couples a voltage containing information of the data voltage to a control terminal of a driving module;
in a light emission phase, the driving module generates a current according to a voltage at the control terminal of the driving module to drive a light-emitting device to emit light.

14. The driving method for the pixel circuit according to claim 13, wherein after the initialization phase and before the data writing phase, the method further comprises:
in a threshold compensation phase, the first initialization module fixes a potential at the second terminal of the coupling module, and a first threshold compensation module performs threshold compensation on a potential at the control terminal of the driving module.

15. An array substrate, comprising at least one set of cascaded gate driving circuits and the pixel circuit according to claim 1, wherein a first scan signal and a second scan signal in the pixel circuit are provided by the same set of gate driving circuits.

16. The array substrate according to claim 15, wherein the at least one set of gate driving circuits comprises multi-stage scan circuits connected in cascade; an i-th stage scan circuit is configured to provide the first scan signal for the pixel circuit in the i-th row, an (i-1)-th stage scan circuit is configured to provide the second scan signal for the pixel circuit in the i-th row; wherein i is a positive integer greater than or equal to 2.

17. The array substrate according to claim 16, wherein the display panel comprises a display area and a non-display area, and the non-display area is disposed to at least partially surround the display area; the pixel circuits are disposed in the display area, and the gate driving circuit is disposed in the non-display area; each stage of the scan circuit comprises a first scan circuit; along a column direction of the pixel circuits, the first scan circuit is disposed on one side of the display area, and the first scan circuit is configured to provide the first scan signal or the second scan signal to a row of the pixel circuits; each stage of the scan circuit further comprises a second scan circuit; along the column direction of the pixel circuits, the second scan circuit is disposed on a side of the display area away from the first scan circuit, and the second scan circuit is configured to provide the first scan signal or the second scan signal to the pixel circuits correspondingly connected to the first scan circuit of the same stage.

18. The array substrate according to claim 17, wherein the pixel circuits are divided into multiple groups, each group of the pixel circuits comprises at least one row of the pixel circuits; at least one group of the gate driving circuit further comprises multiple stages of light emission control circuits cascaded, an (i+1)th stage of the light emission control circuit is configured to provide a first control signal to an ith group of the pixel circuits, and an ith stage of the light emission control circuit is configured to provide a second control signal to the ith group of the pixel circuits; or, each stage of the light emission control circuit is configured to provide the first control signal and the second control signal to each group of the pixel circuits; wherein i is a positive integer greater than or equal to 1.

19. The array substrate according to claim 18, wherein along the column direction of the pixel circuits, the light emission control circuit is disposed on at least one side of the display area; each stage of the light emission control circuit comprises a first light emission control circuit; along the column direction of the pixel circuits, the first light emission control circuit is disposed on one side of the display area, and the first light emission control circuit is configured to provide a control signal to a group of the pixel circuits; along the column direction of the pixel circuits, the first light emission control circuit and the first scan circuit are respectively disposed on two sides of the display area; each stage of the light emission control circuit further comprises a second light emission control circuit; along the column direction of the pixel circuits, the second light emission control circuit is disposed on a side of the display area away from the first light emission control circuit, and the second light emission control circuit is configured to provide a control signal to the pixel circuits correspondingly connected to the first light emission control circuit of the same stage.

20. The array substrate according to claim 18, further comprising a first start signal line, a second start signal line, a first clock signal line, and a second clock signal line, wherein the first start signal line and the first clock signal line are connected to the scan circuit; the second start signal line and the second clock signal line are connected to the light emission control circuit; an effective level of a second start signal provided by the second start signal line is opposite to an effective level of the first control signal, and a first start signal provided by the first start signal line precedes the second start signal; or, a first clock signal provided by the first clock signal line precedes a second clock signal provided by the second clock signal line.
